(19) United States
(12) Patent Application Publication
(10) Pub. No.: US 2026/0193468 A1
(43) Pub. Date: Jul. 9, 2026

(54) YELLOW METHINE DYES AND THEIR USE FOR DYEING PLASTICS

(71) Applicant: LANXESS Deutschland GmbH, Cologne (DE)

(72) Inventors: Hans-Ulrich Borst, Elsdorf (DE); Frank Linke, Cologne (DE); Sabine Schmauser, Leverkusen (DE)

(73) Assignee: LANXESS Deutschland GmbH, Cologne (DE)

(21) Appl. No.: 19/130,576

(22) PCT Filed: Nov. 17, 2023
(86) PCT No.: PCT/EP2023/082183

§ 371 Date: May 16, 2025

(30) Foreign Application Priority Data
Nov. 24, 2022 (EP) 22209278.5

(51) Int. Cl. C09B 23/14; C08K 5/00

(52) U.S. Cl. CPC C09B 23/143; C08K 5/0041

(57) ABSTRACT

The present invention relates to substituted 4-amino-6-methylbenzaldehyde derivatives of formula (I)

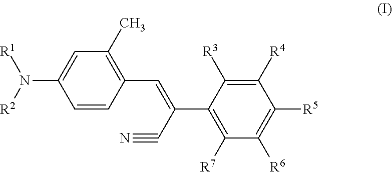

in which
R¹ and R² are identical or different and are each an optionally substituted alkyl, and R³ to R⁷ are identical or different and are each hydrogen, halogen, cyano, optionally substituted alkyl or optionally substituted alkoxy, as novel yellow methine dyes, to methods for the production thereof and to the use thereof for the colouring of plastics.

The present invention relates to substituted 4-amino-6-methylbenzaldehyde derivatives of formula (I)

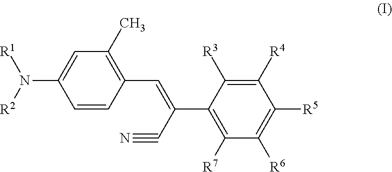

in which
R¹ and R² are identical or different and are each an optionally substituted alkyl, and R³ to R⁷ are identical or different and are each hydrogen, halogen, cyano, optionally substituted alkyl or optionally substituted alkoxy, as novel yellow methine dyes, to methods for the production thereof and to the use thereof for the colouring of plastics.

Although there are already a large number of yellow dyes on the market for colouring plastics, there is still a need for novel dyes with improved properties. In particular, there is still a need for improvement of the known dyes with respect to the two properties of colour strength and thermal stability. This applies in particular to the use of the dyes for the bulk colouring of polyamide.

The bulk colouring of synthetic polyamides places higher demands on the colourants used than the bulk colouring of other plastics. The melting points of synthetic polyamides are considerably higher and the chemical reactivity of molten polyamides, in particular of polyamide 6.6, is also substantially higher, with the result that the heat stability of the colourants used has to be exceptionally good. There are few colourants which meet these high demands, in particular if high light resistance is also additionally required.

EP-A 0225553 describes azo colour lakes that can be used for colouring polyamide in yellow shades. The use of Pigment Yellow 192 is likewise known. EP-A 0074515 discloses nickel-azobarbituric acid complexes that can likewise be used to produce yellow colourings of polyamide.

These known pigments do have good thermal stabilities, however they cannot be used to produce transparent colourings of plastics. Pigments can also impair the mechanical properties of the polymers.

The use of solvent dyes to colour plastics in transparent yellow shades is also known from the prior art. The mechanical properties of the polymers are generally not adversely affected by these dyes.

One known yellow solvent dye is Solvent Yellow 93 (C.I. 48160; CAS No. 4702-90-3), both from the class of methine dyes, but with two 3H-pyrazol-3-one groups in the molecule.

P.-M. Chun et al, Styryl Dyes for Synthetic Polymer Fibers, J. Appl. Chem. Biotechnol. 1978, 28, 463-468 describe the reaction of numerous 4-(N-methyl-N-ß-cyanoethyl)aminobenzaldehydes and 4-(N-ethyl-N-ß-benzyloxyethyl)amino-2-methylbenzaldehydes with reactive methylene components, where they achieve optimal colouring and colour fastness when using malononitrile, ethyl cyanoacetate and 2-cyanomethylbenzimidazole.

A. Thomas et al, Chemistry of Bis-2′-cyanoethyl Derivatives of Some Aromatic Primary Amines, Part I., Journal Indian Chem. Soc., Vol. 41, No. 1, 1964, describe the production and properties of bis-2′-cyanoethyl derivatives of primary amines.

JP S61 270747 A describes photopolymerizable compositions with high sensitivity in relation to laser beams and uses 1-cyano-2-(P-dialkylaminophenyl)ethylene derivatives and 1-cyano-4-(P-dialkylaminophenyl)-1,3-butadiene derivatives as photoinitiator or as photoinitiator system.

However, the properties of these colourants known from the prior art are not sufficient for the currently existing technical requirements and are still in need of improvement in particular in terms of their fastness, such as light and heat resistance. In particular, there is a lack of those colourants that absorb in the short-wave spectral range (absorption maximum approx. 380 to 420 nm).

It has surprisingly been found that the reaction of substituted 4-amino-6-methylbenzaldehydes of formula (II)

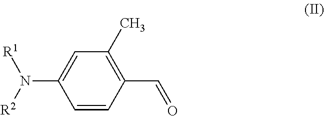

in which
R¹ and R² are identical or different and are each optionally substituted alkyl, and phenylacetonitrile derivatives of formula (III)

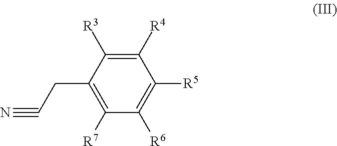

in which R³ to R⁷ are identical or different and are each hydrogen, halogen, cyano, optionally substituted alkyl or optionally substituted alkoxy, yields substituted 4-amino-6-methylbenzaldehyde derivatives for use as heat-stable or thermally stable methine dyes that are suitable for use in polymers or plastics.

The present invention provides substituted 4-amino-6-methylbenzaldehyde derivatives or dyes of formula (I)

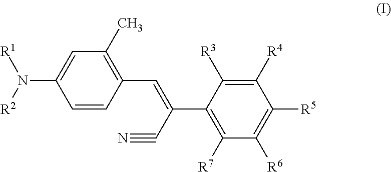

in which
R¹ and R² are identical or different and are each optionally substituted alkyl, R³ to R⁷ are identical or different and are each hydrogen, halogen, cyano, optionally substituted alkyl or optionally substituted alkoxy.

Alternatively, the invention provides for the use of the substituted 4-amino-6-methylbenzaldehyde derivatives of formula (I) obtainable from substituted 4-amino-6-methylbenzaldehydes of formula (II)

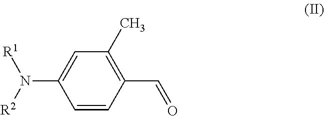

in which
R¹ and R² have the general and preferred definitions given for formula (I), and phenylacetonitrile derivatives of formula (III)

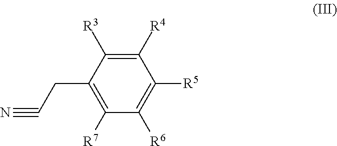

in which R³, R⁴, R⁵, R⁶ and R⁷ have the general and preferred definitions given for formula (I), as thermally stable dyes in plastics or polymers, with the proviso that “thermally stable” means a heat stability to be determined in accordance with DIN EN 12877-2 Method A (“Determination of colour stability to heat during processing of colouring materials in plastics”) on the respective pelletized plastic of ≥385° C.

The present invention further provides for the use of the substituted 4-amino-6-methylbenzaldehyde derivatives of formula (I) according to the invention as thermally stable dyes in plastics or polymers, preferably for the bulk colouring of plastics. The substituted 4-amino-6-methylbenzaldehyde derivatives of formula (I) to be used according to the invention can be used here individually or in any desired mixture with one another.

For the sake of clarity, it should be noted that the scope of the present invention encompasses all the definitions and parameters cited in general or in preferred ranges, in any desired combinations. This especially also relates to the stated amounts and parameters of the individual components to be used in the methods and uses claimed in the context of the present application. The standards cited in the context of this application each relate to the edition current at the filing date of the present invention. The terms “thermally stable” and “heat-stable” are synonymous in the context of the present invention.

Alkyl in the definition of R¹ to R⁷ is a straight-chain or branched saturated hydrocarbon radical which is optionally mono- or polysubstituted identically or differently. The alkyl radicals mentioned preferably comprise 1 to 6 carbon atoms, particularly preferably 1 to 4 carbon atoms. The alkyl radicals mentioned are in particular methyl, ethyl, n-propyl, isopropyl, n-butyl, sec-butyl, isobutyl and tert-butyl, each of which is optionally mono- or polysubstituted identically or differently.

Alkoxy in the definition of R³ to R⁷ is an alkyl radical which is connected to the remaining part of the molecule via an oxygen atom, where alkyl is a straight-chain or branched saturated hydrocarbon radical which is optionally mono- or polysubstituted identically or differently. The alkoxy radicals mentioned preferably comprise 1 to 6 carbon atoms, particularly preferably 1 to 4 carbon atoms.

The alkoxy radicals mentioned are in particular methoxy, ethoxy, n-propoxy, isopropoxy, n-butoxy, sec-butoxy, isobutoxy and tert-butoxy, each of which is optionally mono- or polysubstituted identically or differently.

In the definition of R¹ to R⁷, the alkyl radicals mentioned are unsubstituted or mono- or polysubstituted identically or differently. Suitable substituents for the alkyl radicals mentioned are for example halogen atoms, in particular fluorine and/or chlorine atoms, and/or aryloxy radicals.

The aryloxy radicals are aromatic hydrocarbon radicals having 6 to 10 carbon atoms which are unsubstituted or mono- or polysubstituted identically or differently and the aryl moiety of which is connected to the remaining part of the molecule via an oxygen atom. The aryloxy radicals are in particular phenoxy or naphthoxy radicals. Suitable substituents for the aryloxy radicals mentioned are halogen atoms, preferably fluorine or chlorine; alkyl, preferably C₁-C₁₆ alkyl, in particular n-propyl, isopropyl, butyl, isobutyl, tert-butyl, isooctyl, isononyl, lauryl; alkoxy, preferably C₁-C₄ alkoxy, in particular methoxy and ethoxy; furthermore cycloalkyl, preferably C₅-C₇ cycloalkyl, in particular cyclopentyl and cyclohexyl, and aryl, preferably phenyl.

Halogen in the definition of R³ to R⁶ is in particular fluorine and chlorine.

Preferred are substituted 4-amino-6-methylbenzaldehyde derivatives of formula (I), and the use thereof as thermally stable dyes, in which
R¹ and R² are independently unsubstituted C₁-C₄ alkyl or C₁-C₄ alkyl which is substituted by a phenoxy or naphthoxy radical which in each case is optionally mono- or disubstituted identically or differently,
and
R³ to R⁷ are independently hydrogen, halogen, cyano, unsubstituted C₁-C₄ alkyl or C₁-C₄ alkyl which is mono- to trisubstituted identically or differently by halogen, unsubstituted C₁-C₄ alkoxy or C₁-C₄ alkoxy which is mono- to trisubstituted identically or differently by halogen.

Particularly preferred are substituted 4-amino-6-methylbenzaldehyde derivatives of formula (I), and the use thereof as thermally stable dyes, in which
R¹ is unsubstituted C₁-C₄ alkyl,
R² is unsubstituted C₁-C₄ alkyl or is C₁-C₄ alkyl which in each case is monosubstituted by a radical of formula

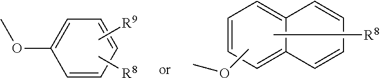

in which
R⁸ is halogen, unsubstituted C₁-C₄ alkyl, unsubstituted C₅-C₇ cycloalkyl or unsubstituted phenyl,
and
R⁹ is hydrogen or unsubstituted C₁-C₄ alkoxy,
R³ is hydrogen, halogen, or cyano,
R⁴ is hydrogen, halogen, unsubstituted C₁-C₄ alkyl or C₁-C₄ alkyl which is mono- to trisubstituted identically or differently by halogen,
R⁵ is hydrogen, halogen, cyano or unsubstituted C₁-C₄ alkoxy,
R⁶ is hydrogen, and
R⁷ is hydrogen, halogen or cyano.

Very particularly preferred are substituted 4-amino-6-methylbenzaldehyde derivatives of formula (I), and the use thereof as thermally stable dyes, in which
R¹ is methyl, ethyl, n-propyl or isopropyl,
R² is methyl, ethyl, n-propyl or isopropyl or is methyl, ethyl, n-propyl or isopropyl which in each case is monosubstituted by a radical of formula

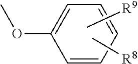

in which
R⁸ is methyl, ethyl, n-propyl, isopropyl, cyclopentyl, cyclohexyl or phenyl,
R⁹ is hydrogen, methoxy or ethoxy,
R³ is hydrogen, fluorine or chlorine,
R⁴ is hydrogen, fluorine, chlorine, methyl or trifluoromethyl,
R⁵ is hydrogen, fluorine, chlorine, methoxy or ethoxy,
R⁶ is hydrogen, and
R⁷ is hydrogen, fluorine or chlorine.

Especially preferred are substituted 4-amino-6-methylbenzaldehyde derivatives of formula (I), and the use thereof as thermally stable dyes, in which
R¹ is methyl or ethyl,
R² is methyl or ethyl or is methyl or ethyl which in each case is monosubstituted by a radical of formula

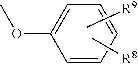

in which
R⁸ is methyl, ethyl, n-propyl, isopropyl, cyclohexyl or phenyl, and
R⁹ is hydrogen or methoxy,
R³ is hydrogen, fluorine or chlorine,
R⁴ is hydrogen, fluorine, chlorine or trifluoromethyl,
R⁵ is hydrogen, fluorine, chlorine or methoxy,
R⁶ is hydrogen, and
R⁷ is hydrogen or chlorine.

The dyes of formula (I) according to the invention make it possible to produce yellow colourings of plastics, in particular of polyamides, which surprisingly feature improved light fastness and improved thermal stabilities in comparison with the known yellow dyes used for these purposes. In addition, the dyes according to the invention make it possible to meet the demand for high-quality yellow dyes that absorb in the short-wave spectral range.

The substituted 4-amino-6-methylbenzaldehyde derivatives of formula (I) according to the invention make it possible to significantly surpass the property profiles achieved to date of known yellow dyes for colouring plastics.

As described above, the invention also provides for the use of the substituted 4-amino-6-methylbenzaldehyde derivatives of formula (I) for the bulk colouring of plastics, where bulk colouring is understood in particular to mean methods in which the dye is incorporated into the molten plastics compound, in particular with the aid of an extruder, or in which the substituted 4-amino-6-methylbenzaldehyde derivative of formula (I) has already been added to the reactants for producing the plastic, in particular the monomers, before the polymerization.

Particularly preferred plastics are thermoplastics, very particularly preferably vinyl polymers, polyesters, polyamides, and polyolefins, in particular polyethylene and polypropylene, polycarbonates, polyamides and polymethylmethacrylates. Very particular preference is given to polyamides, in particular polyamide 6.6 and polyamide 6.

Within the meaning the present invention, the term “polyamides” is used to refer to synthetic, industrially usable thermoplastics and thus differentiates this substance class from the chemically related proteins. Almost all significant polyamides are derived from primary amines, since the repeating unit consists of the —CO—NH— functional group. In addition, polyamides of secondary amines (—CO—NR—, R=organic radical) also exist. In particular, aminocarboxylic acids, lactams and/or diamines and dicarboxylic acids serve as monomers for the production of polyamides.

Polyamide 6.6 (CAS No. 32131-17-2) is usually produced from hexamethylenediamine (HMD) and adipic acid. It is formed by a polycondensation with elimination of water. Polyamide 6 (CAS No. 25028-54-4) is obtainable by ring-opening polymerization of ε-caprolactam with water as starter.

Preferred vinyl polymers include polystyrene, styrene-acrylonitrile copolymers, styrene-butadiene copolymers, styrene-butadiene-acrylonitrile terpolymers, polymethacrylate and polyvinyl chloride.

Preferred polyesters are polyethylene terephthalates, polybutylene terephthalates, polycarbonates and cellulose esters.

The plastics to be coloured may be present individually or as mixtures with one another, as plastic compounds or melts.

When they are used for the bulk colouring of plastics, the substituted 4-amino-6-methylbenzaldehyde derivatives of formula (I) according to the invention are preferably employed in finely divided form, with the concomitant use of dispersants being possible but not mandatory.

When they are used for the bulk colouring of plastics, the substituted 4-amino-6-methylbenzaldehyde derivatives of formula (I) according to the invention may be used for example directly in the process of the plastic production after the polymerization is complete. In this case, at least one dye (I) according to the invention is preferably ground or mixed in dry form with the pelletized plastic and this mixture is plasticized and homogenized for example on mixing rollers or in screws. Alternatively, the substituted 4-amino-6-methylbenzaldehyde derivatives of formula (I) according to the invention may be added to the molten compound and homogeneously distributed by stirring. The material pre-coloured in this way may then be processed further as usual for example by spinning, by extrusion or in injection moulding processes to give mouldings.

Within the meaning of the present invention, the term “mouldings” should be understood to mean three-dimensional bodies of any desired spatial form, in particular bristles, threads, fibres, films and sheets.

Since the substituted 4-amino-6-methylbenzaldehyde derivatives of formula (I) according to the invention are surprisingly resistant to polymerization catalysts, in particular peroxides, it is also possible to add them to the monomeric starting materials for the plastic preparation, for example of polymethylmethacrylate (PMMA), and to then polymerize them in the presence of polymerization catalysts. For this purpose, they are preferably dissolved in the monomeric components or intimately mixed with them.

The substituted 4-amino-6-methylbenzaldehyde derivatives of formula (I) according to the invention are preferably used for the colouring of the plastics mentioned, in particular polyamide, in amounts from 0.0001% to 1% by weight, in particular 0.01% to 0.5% by weight, based on the amount of polymer.

By adding pigments that are insoluble in the polymers, in particular titanium dioxide, it is possible to obtain corresponding valuable muted colourings. In this case, titanium dioxide may be present in an amount from 0.01% to 10% by weight, preferably 0.1% to 5% by weight, based on the amount of polymer.

The present invention further provides a method for the bulk colouring of plastics, where at least one substituted 4-amino-6-methylbenzaldehyde derivative of formula (I) is ground or mixed in dry form with at least one plastic, preferably in pellet form, and this mixture is plasticized and homogenized for example on mixing rollers or in screws.

Alternatively, the substituted 4-amino-6-methylbenzaldehyde derivatives of formula (I) according to the invention may be added to the molten compound and homogeneously distributed by stirring. It is also possible to add the substituted 4-amino-6-methylbenzaldehydes of formula (I) according to the invention to the monomeric reactants during the plastic production and then to polymerize them.

The material pre-coloured in this way may then be processed further preferably by spinning to give bristles, threads etc. or by extrusion or in injection moulding processes to give mouldings.

These methods yield transparent or opaque brilliant yellow colourings with very good heat or thermal stability and light resistance.

To carry out such methods, it is also possible to use mixtures of the substituted 4-amino-6-methylbenzaldehyde derivatives of formula (I) according to the invention with other dyes and/or inorganic and/or organic pigments.

The present invention further provides plastics compositions comprising at least one thermoplastic and at least one substituted 4-amino-6-methylbenzaldehyde derivative of formula (I).

Preferably, the plastics compositions according to the invention comprise at least one thermoplastic from the series of vinyl polymers, polyesters, polyamides, and polyolefins, particularly preferably polyethylene and polypropylene, polycarbonates, polyamides and polyacrylmethacrylate.

Very particularly preferably, the plastics compositions according to the invention comprise at least one polyamide, in particular polyamide 6.6 and/or polyamide 6.

The plastics compositions according to the invention may comprise the thermoplastic also in the form of the respective polymerizable monomers.

The plastics compositions according to the invention comprise the thermoplastic in finely divided form, preferably in the form of pellets.

The plastics compositions according to the invention may comprise one or more dyes, organic or inorganic pigments, and customary auxiliaries and additives in the amounts customary for these substances.

To produce muted colourings, the plastics compositions according to the invention preferably comprise titanium dioxide in an amount from 0.01% to 10% by weight, preferably 0.1% to 5% by weight, based on the amount of thermoplastics.

The plastics compositions according to the invention may be produced in a known manner, for example by mixing or grinding at least one thermoplastic, preferably in pellet form, with at least one substituted 4-amino-6-methylbenzaldehyde derivative of formula (I).

The present invention further provides a method for producing the substituted 4-amino-6-methylbenzaldehyde derivatives of formula (I) according to the invention.

The substituted 4-amino-6-methylbenzaldehyde derivatives of formula (I) according to the invention may be prepared in a manner known per se, by reacting at least one substituted 4-amino-6-methylbenzaldehyde of formula (II)

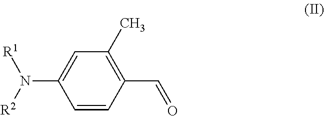

in which
R¹ and R² have the general and preferred definitions given for formula (I), with at least one phenylacetonitrile derivative of formula (III)

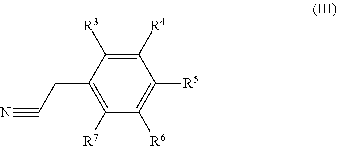

in which
R³. R⁴, R⁵, R⁶ and R⁷ have the general and preferred definitions given for formula (I).

The method according to the invention for producing the dyes of formula (I) by reacting substituted 4-amino-6-methylbenzaldehydes of formula (II) with the phenylacetonitrile derivatives of formula (III) may be carried out in a manner known per se.

In general, the method according to the invention is carried out such that the substituted 4-amino-6-methylbenzaldehyde (II) is firstly initially charged and the phenylacetonitrile derivative (III) is added and, after reaction is complete, the dye of formula (I) is isolated. The isolation may be effected by customary processes, preferably by filtration. The reaction product obtained may optionally be worked up by further method steps such as washing and drying.

To carry out the method according to the invention, use is generally made of 0.8 to 1.5 mol, preferably 0.9 to 1.1 mol and particularly preferably 1.0 mol of phenylacetonitrile derivative (II)) per mole of substituted 4-amino-6-methylbenzaldehyde (II).

The method according to the invention may be carried out in the presence of at least one solvent. Suitable solvents are for example those from the series of alcohols and formamides. Preferably, the method for producing the dyes (I) according to the invention is carried out in the presence of at least one alcohol from the series of methanol, ethanol, propanol, and/or at least one formamide from the series of dimethylformamide and diethylformamide, particularly preferably in the presence of methanol and/or dimethylformamide.

The method according to the invention may be carried out in the presence of at least one base. Suitable bases are for example alkali metal hydroxides and alkali metal alkoxides. Preference is given to the use of lithium hydroxide, sodium hydroxide, potassium hydroxide and/or potassium tert-butoxide, particularly preferably sodium hydroxide and/or potassium tert-butoxide.

The method according to the invention is generally carried out at a temperature in the range from −10° C. to 180° C., preferably from 0° C. to 100° C. and particularly preferably from 10° C. to 90° C.

Advantageously, the method according to the invention is carried out at ambient pressure, but the reaction may also be carried out in the range from 1000 to 10 000 hPa, preferably 10 to 5000 hPa. Ambient pressure should be understood to mean an air pressure in the range from about 925 hPa to 1070 hPa.

The phenylacetonitrile derivatives of formula (III) are known and can be purchased for example as commercial products from Alfa Aesar.

Compounds of formula (III) that are preferred for carrying out the method according to the invention are 3-(trifluoromethyl)phenylacetonitrile, 4-methoxyphenylacetonitrile, 2,6-dichlorophenylacetonitrile, 2,4-chlorophenylacetonitrile, 3,4-chlorophenylacetonitrile, 2-fluorophenylacetonitrile, 3-chlorophenylacetonitrile, 3-fluorophenylacetonitrile, 4-chlorophenylacetonitrile and 4-fluorophenylacetonitrile.

The aldehydes of formula (II) that are used to carry out the method according to the invention are known and can be produced in a manner known to those skilled in the art, for example by the Vilsmeier-Haack reaction known from the literature.

In this case, to produce the compounds of formula (II), at least one aniline derivative of formula (IV)

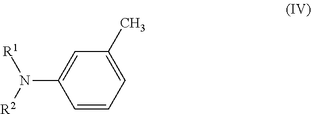

in which
R¹ and R² have the general and preferred definitions given for formula (I), is reacted with at least one formylation reagent.

In general, the reaction is carried out such that at least one compound of formula (IV) is initially charged and the formylation reagent is added, optionally in the presence of at least one solvent, and subsequently the thus produced aldehyde of formula (II) is precipitated, optionally by addition of a suitable amount of a suitable precipitant, and the aldehyde of formula (II) is then isolated by customary methods, for example by filtration.

The formylation reagent used is generally a mixture of at least one formamide and at least one phosphoric acid chloride.

Preferred formamides are dimethylformamide, diethylformamide and dibutylformamide.

A preferred phosphoric acid chloride is phosphorus oxychloride.

The reaction is generally carried out at a temperature in the range between 10° C. and 90° C., preferably from 20° C. to 80° C. and particularly preferably from 30° C. to 70° C.

Advantageously, the method for producing the compounds (II) is carried out at ambient pressure, but the reaction may also be carried out in the range from 1000 to 10 000 hPa, preferably 10 to 5000 hPa. Ambient pressure should be understood to mean an air pressure in the range from about 925 hPa to 1070 hPa.

The reaction may be carried out in the presence of at least one solvent. Suitable solvents are for example formamides. Preference is given to dimethylformamide and diethylformamide; particular preference is given to the use of dimethylformamide. When using dimethylformamide, it is especially preferable to use this in excess, the dimethylformamide then simultaneously serving as formylation reagent and as solvent.

The formylation reagent used is particularly preferably a mixture of dimethylformamide and phosphorus oxychloride.

In general, at least one mole of formylation reagent, preferably 1.1 to 1.5 mol and particularly preferably 1.1 to 1.0 mol, is used per mole of compound of formula (IV).

Suitable precipitants for the precipitation of the compounds of formula (II) are for example water and alcohols such as methanol and/or ethanol.

Aniline derivatives of formula (IV) are known and can be purchased as commercial products for example from Merck, TCI or Sigma Aldrich.

The invention is elucidated, but not restricted, by the examples which follow.

### EXAMPLES

### Production of the Compounds of Formula (I)

### Example 1

### Production of an Inventive Compound of Formula (I-1)

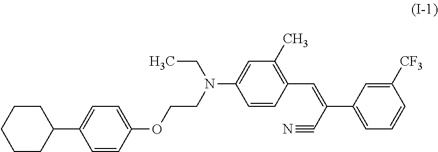 [SMILES: CCN(CCOc1ccc(C2CCCCC2)cc1)c1ccc(/C=C(\C#N)c2cccc(C(F)(F)F)c2)c(C)c1]

36.6 g (0.10 mol) of the aldehyde of formula (IIa) produced according to Example A and 18.5 g (0.10 mol) of 3-(trifluoromethyl)phenylacetonitrile were introduced into 200 ml of methanol. Subsequently, the pH was adjusted to about 10 with approx. 1 g of a 50% aqueous potassium hydroxide solution and the reaction mixture was heated to a temperature of 60° C. and then stirred for 6 hours. The mixture was then cooled to 25° C. and the reaction product was isolated on a suction filter. The filter cake was washed with approx. 300 ml of methanol and approx. 1000 ml of water at a temperature of 90° C. The washed product was dried in a vacuum drying cabinet at a temperature of 80° C. and a pressure of 20 000 Pa.

Yield: 46.9 g (corresponds to 88% of theory), melting point 101° C.

### Examples 2 to 28

The compounds of Examples 2 to 28 were each produced and worked up analogously to Example 1, but with the following deviations:

### Example 2

### Production of an Inventive Compound of Formula (1-2)

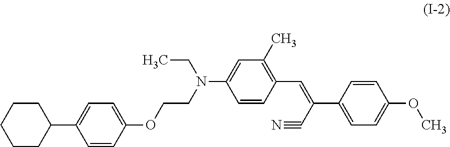 [SMILES: CCN(CCOc1ccc(C2CCCCC2)cc1)c1ccc(/C=C(\C#N)c2ccc(OC)cc2)c(C)c1]

Instead of the 3-(trifluoromethyl)phenylacetonitrile used in Example 1, 14.7 g (0.10 mol) of 4-methoxyphenylacetonitrile was used.

Yield: 36.7 g (corresponds to 74% of theory), melting point 104° C.

### Example 3

### Production of an Inventive Compound of Formula (1-3)

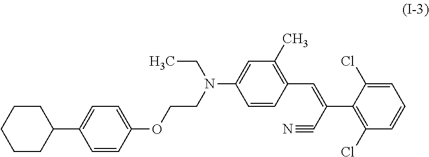 [SMILES: CCN(CCOc1ccc(C2CCCCC2)cc1)c1ccc(/C=C(\C#N)c2c(Cl)cccc2Cl)c(C)c1]

Instead of the 3-(trifluoromethyl)phenylacetonitrile used in Example 1, 18.6 g (0.10 mol) of 2,6-dichlorophenylacetonitrile was used.

Yield: 37.9 g (corresponds to 71% of theory), melting point 123° C.

### Example 4

### Production of an Inventive Compound of Formula (I-4)

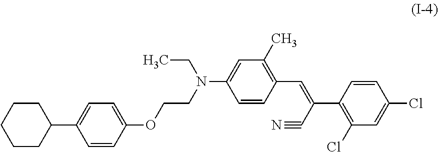 [SMILES: CCN(CCOc1ccc(C2CCCCC2)cc1)c1ccc(/C=C(\C#N)c2ccc(Cl)cc2Cl)c(C)c1]

Instead of the 3-(trifluoromethyl)phenylacetonitrile used in Example 1, 18.6 g (0.10 mol) of 2,4-dichlorophenylacetonitrile was used.

Yield: 36.8 g (corresponds to 69% of theory), melting point 121° C.

### Example 5

### Production of an Inventive Compound of Formula (1-5)

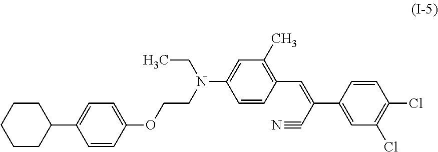 [SMILES: CCN(CCOc1ccc(C2CCCCC2)cc1)c1ccc(/C=C(\C#N)c2ccc(Cl)c(Cl)c2)c(C)c1]

Instead of the 3-(trifluoromethyl)phenylacetonitrile used in Example 1, 18.6 g (0.10 mol) of 3,4-dichlorophenylacetonitrile was used.

Yield: 47.5 g (corresponds to 89% of theory), melting point 132° C.

### Example 6

### Production of an Inventive Compound of Formula (I-6)

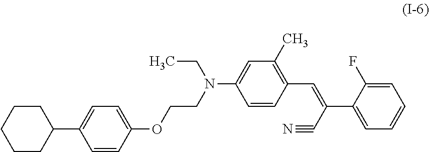 [SMILES: CCN(CCOc1ccc(C2CCCCC2)cc1)c1ccc(/C=C(\C#N)c2ccccc2F)c(C)c1]

Instead of the 3-(trifluoromethyl)phenylacetonitrile used in Example 1, 13.5 g (0.10 mol) of 2-fluorophenylacetonitrile was used.

Yield: 38.1 g (corresponds to 79% of theory), melting point 107° C.

### Example 7

### Production of an Inventive Compound of Formula (1-7)

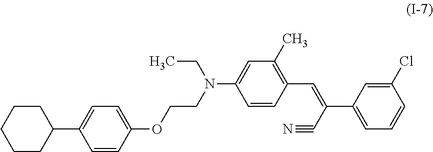 [SMILES: CCN(CCOc1ccc(C2CCCCC2)cc1)c1ccc(/C=C(\C#N)c2cccc(Cl)c2)c(C)c1]

Instead of the 3-(trifluoromethyl)phenylacetonitrile used in Example 1, 15.2 g (0.10 mol) of 3-chlorophenylacetonitrile was used.

Yield: 42.4 g (corresponds to 85% of theory), melting point 111° C.

### Example 8

### Production of an Inventive Compound of Formula (1-8)

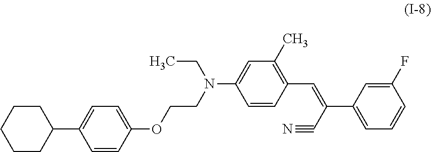 [SMILES: CCN(CCOc1ccc(C2CCCCC2)cc1)c1ccc(/C=C(\C#N)c2cccc(F)c2)c(C)c1]

Instead of the 3-(trifluoromethyl)phenylacetonitrile used in Example 1, 13.5 g (0.10 mol) of 3-fluorophenylacetonitrile was used.

Yield: 40.1 g (corresponds to 83% of theory), melting point 120° C.

### Example 9

### Production of an Inventive Compound of Formula (1-9)

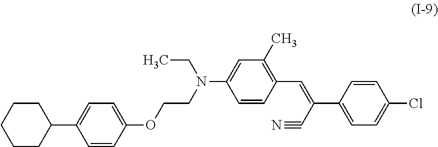 [SMILES: CCN(CCOc1ccc(C2CCCCC2)cc1)c1ccc(/C=C(\C#N)c2ccc(Cl)cc2)c(C)c1]

Instead of the 3-(trifluoromethyl)phenylacetonitrile used in Example 1, 15.2 g (0.10 mol) of 4-chlorophenylacetonitrile was used.

Yield: 41.4 g (corresponds to 83% of theory), melting point 126° C.

### Example 10

### Production of an Inventive Compound of Formula (1-10)

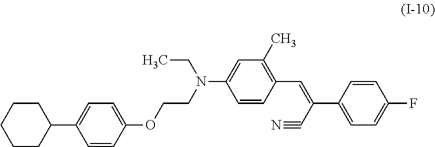 [SMILES: CCN(CCOc1ccc(C2CCCCC2)cc1)c1ccc(/C=C(\C#N)c2ccc(F)cc2)c(C)c1]

Instead of the 3-(trifluoromethyl)phenylacetonitrile used in Example 1, 13.5 g (0.10 mol) of 4-fluorophenylacetonitrile was used.

Yield: 37.6 g (corresponds to 78% of theory), melting point 133° C.

### Example 11

### Production of an Inventive Compound of Formula (I-11)

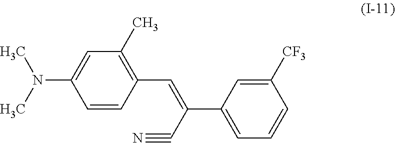 [SMILES: Cc1cc(N(C)C)ccc1/C=C(\C#N)c1cccc(C(F)(F)F)c1]

Instead of the aldehyde of formula (II-a) used in Example 1, 16.3 g (0.1 mol) of the aldehyde of formula (II-b) produced according to Example B) was used.

Yield: 29.4 g (corresponds to 89% of theory), melting point 123° C.

### Example 12

### Production of an Inventive Compound of Formula (1-12)

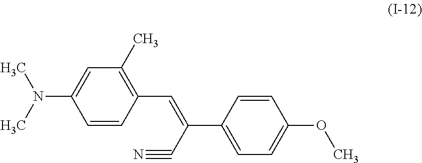

Instead of the aldehyde used in Example 1, 16.3 g (0.1 mol) of the aldehyde of formula (II-b) produced used, and instead of 3-according to Example B) was (trifluoromethyl)phenylacetonitrile, 14.7 g (0.1 mol) of 4-methoxyphenylacetonitrile was used.

Yield: 22.2 g (corresponds to 76% of theory), melting point 166° C.

### Example 13

### Production of an Inventive Compound of Formula (1-13)

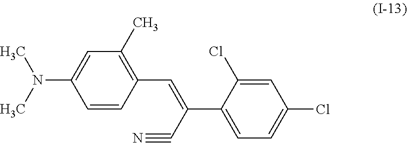 [SMILES: Cc1cc(N(C)C)ccc1/C=C(\C#N)c1ccc(Cl)cc1Cl]

Instead of the aldehyde used in Example 1, 16.3 g (0.1 mol) of the aldehyde of formula (II-b) produced according and to Example B) was used, instead of 3 (trifluoromethyl)phenylacetonitrile, 18.6 g (0.1 mol) of 2,4-dichlorophenylacetonitrile was used.

Yield: 23.8 g (corresponds to 72% of theory), melting point 129° C.

### Example 14

### Production of an Inventive Compound of Formula (I-14)

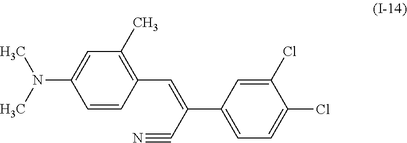 [SMILES: Cc1cc(N(C)C)ccc1/C=C(\C#N)c1ccc(Cl)c(Cl)c1]

Instead of the aldehyde used in Example 1, 16.3 g (0.1 mol) of the aldehyde of formula (II-b) produced according to Example B) was used, and instead of 3-(trifluoromethyl)phenylacetonitrile, 18.6 g (0.1 mol) of 3,4-dichlorophenylacetonitrile was used.

Yield: 26.8 g (corresponds to 81% of theory), melting point 155° C.

### Example 15

### Production of an Inventive Compound of Formula (1-15)

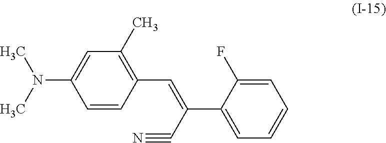 [SMILES: Cc1cc(N(C)C)ccc1/C=C(\C#N)c1ccccc1F]

Instead of the aldehyde used in Example 1, 16.3 g (0.1 mol) of the aldehyde of formula (II-b) produced according to Example B) was used, and instead of 3-(trifluoromethyl)phenylacetonitrile, 13.5 g (0.1 mol) of 2-fluorophenylacetonitrile was used.

Yield: 22.4 g (corresponds to 80% of theory), melting point 122° C.

### Example 16

### Production of an Inventive Compound of Formula (I-16)

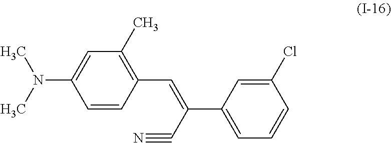 [SMILES: Cc1cc(N(C)C)ccc1/C=C(\C#N)c1cccc(Cl)c1]

Instead of the aldehyde used in Example 1, 16.3 g (0.1 mol) of the aldehyde of formula (II-b) produced according to Example B) was used, and instead of 3-(trifluoromethyl)phenylacetonitrile, 15.2 g (0.1 mol) of 3-chlorophenylacetonitrile was used.

Yield: 23.7 g (corresponds to 80% of theory), melting point 107° C.

### Example 17

### Production of an Inventive Compound of Formula (I-17)

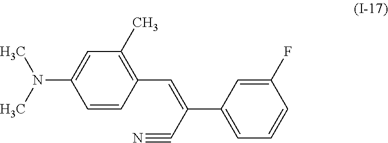 [SMILES: Cc1cc(N(C)C)ccc1/C=C(\C#N)c1cccc(F)c1]

Instead of the aldehyde used in Example 1, 16.3 g (0.1 mol) of the aldehyde of formula (II-b) produced according to Example B) was used, and instead of 3-(trifluoromethyl)phenylacetonitrile, 13.5 g (0.1 mol) of 3-fluorophenylacetonitrile was used.

Yield: 21.0 g (corresponds to 75% of theory), melting point 115° C.

### Example 18

### Production of an Inventive Compound of Formula (I-18)

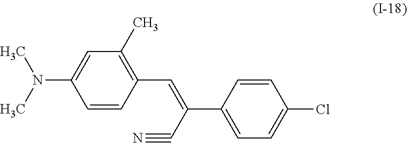 [SMILES: Cc1cc(N(C)C)ccc1/C=C(\C#N)c1ccc(Cl)cc1]

Instead of the aldehyde used in Example 1, 16.3 g (0.1 mol) of the aldehyde of formula (II-b) produced according used, instead of 3- to Example B) was and (trifluoromethyl)phenylacetonitrile, 15.2 g (0.1 mol) of 4-chlorophenylacetonitrile was used.

Yield: 25.2 g (corresponds to 85% of theory), melting point 146° C.

### Example 19

### Production of an Inventive Compound of Formula (I-19)

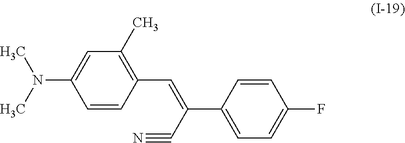 [SMILES: Cc1cc(N(C)C)ccc1/C=C(\C#N)c1ccc(F)cc1]

Instead of the aldehyde used in Example 1, 16.3 g (0.1 mol) of the aldehyde of formula (II-b) produced instead of 3-according to Example B) was used, and (trifluoromethyl)phenylacetonitrile, 13.5 g (0.1 mol) of 4-fluorophenylacetonitrile was used.

Yield: 23.0 g (corresponds to 82% of theory), melting point 136° C.

### Example 20

### Production of an Inventive Compound of Formula (I-20)

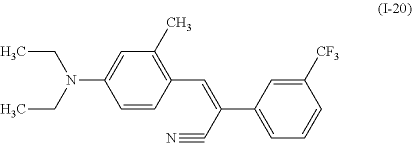 [SMILES: CCN(CC)c1ccc(/C=C(\C#N)c2cccc(C(F)(F)F)c2)c(C)c1]

Instead of the aldehyde used in Example 1, 19.1 g (0.1 mol) of the aldehyde of formula (II-c) produced according to Example C) was used.

Yield: 30.5 g (corresponds to 85% of theory), melting point 124° C.

### Example 21

### Production of an Inventive Compound of Formula (1-21)

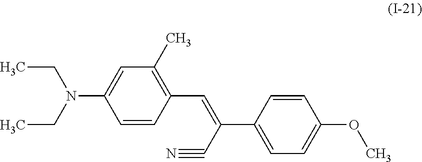 [SMILES: CCN(CC)c1ccc(/C=C(\C#N)c2ccc(OC)cc2)c(C)c1]

Instead of the aldehyde used in Example 1, 19.1 g (0.1 mol) of the aldehyde of formula (II-c) produced according to Example C) and 14.7 g (0.1 mol) of 4-methoxyphenylacetonitrile were used.

Yield: 24.0 g (corresponds to 75% of theory), melting point 103° C.

### Example 22

### Production of an Inventive Compound of Formula (1-22)

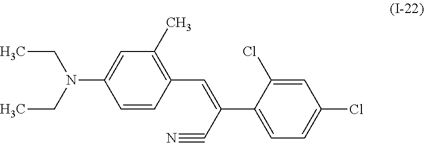 [SMILES: CCN(CC)c1ccc(/C=C(\C#N)c2ccc(Cl)cc2Cl)c(C)c1]

Instead of the aldehyde used in Example 1, 19.1 g (0.1 mol) of the aldehyde of formula (II-c) produced according to Example C) and 18.6 g (0.1 mol) of 2,4-dichlorophenylacetonitrile were used.

Yield: 25.2 g (corresponds to 70% of theory), melting point 83° C.

### Example 23

### Production of an Inventive Compound of Formula (1-23)

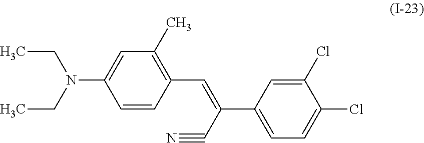 [SMILES: CCN(CC)c1ccc(/C=C(\C#N)c2ccc(Cl)c(Cl)c2)c(C)c1]

Instead of the aldehyde used in Example 1, 19.1 g (0.1 mol) of the aldehyde of formula (II-c) produced according to Example C) and 18.6 g (0.1 mol) of 3,4-dichlorophenylacetonitrile were used.

Yield: 28.4 g (corresponds to 79% of theory), melting point 146° C.

### Example 24

### Production of an Inventive Compound of Formula (1-24)

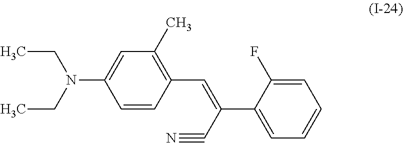 [SMILES: CCN(CC)c1ccc(/C=C(\C#N)c2ccccc2F)c(C)c1]

Instead of the aldehyde used in Example 1, 19.1 g (0.1 mol) of the aldehyde of formula (II-c) produced according to Example C) and 13.5 g (0.1 mol) of 2-fluorophenylacetonitrile were used.

Yield: 23.7 g (corresponds to 77% of theory), melting point 82° C.

### Example 25

### Production of an Inventive Compound of Formula (I-25)

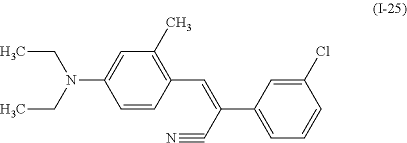 [SMILES: CCN(CC)c1ccc(/C=C(\C#N)c2cccc(Cl)c2)c(C)c1]

Instead of the aldehyde used in Example 1, 19.1 g (0.1 mol) of the aldehyde of formula (II-c) produced according to Example C) and 15.2 g (0.1 mol) of 3-chlorophenylacetonitrile were used.

Yield: 25.3 g (corresponds to 78% of theory), melting point 102° C.

### Example 26

### Production of an Inventive Compound of Formula (1-26)

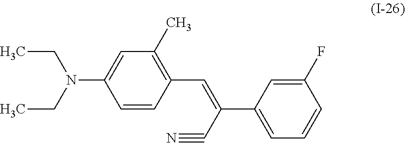 [SMILES: CCN(CC)c1ccc(/C=C(\C#N)c2cccc(F)c2)c(C)c1]

Instead of the aldehyde used in Example 1, 19.1 g (0.1 mol) of the aldehyde of formula (II-c) produced according to Example C) and 13.5 g (0.1 mol) of 3-fluorophenylacetonitrile were used.

Yield: 22.2 g (corresponds to 72% of theory), melting point 122° C.

### Example 27

### Production of an Inventive Compound of Formula (I-27)

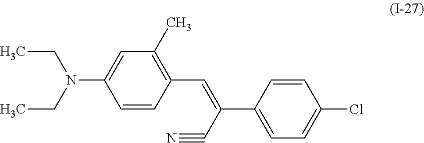 [SMILES: CCN(CC)c1ccc(/C=C(\C#N)c2ccc(Cl)cc2)c(C)c1]

Instead of the aldehyde used in Example 1, 19.1 g (0.1 mol) of the aldehyde of formula (II-c) produced according to Example C) and 15.2 g (0.1 mol) of 4-chlorophenylacetonitrile were used.

Yield: 27.0 g (corresponds to 83% of theory), melting point 137° C.

### Example 28

### Production of an Inventive Compound of Formula (I-28)

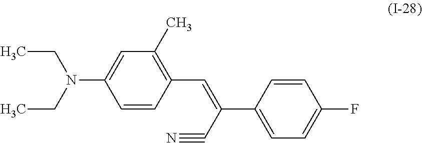 [SMILES: CCN(CC)c1ccc(/C=C(\C#N)c2ccc(F)cc2)c(C)c1]

Instead of the aldehyde used in Example 1, 19.1 g (0.1 mol) of the aldehyde of formula (II-c) produced according to Example C) and 13.5 g (0.1 mol) of 4-fluorophenylacetonitrile were used.

Yield: 25.3 g (corresponds to 82% of theory), melting point 113° C.

### Example 29

### Production of an Inventive Compound of Formula (1-29)

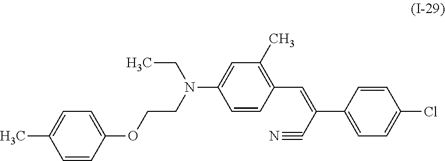 [SMILES: CCN(CCOc1ccc(C)cc1)c1ccc(/C=C(\C#N)c2ccc(Cl)cc2)c(C)c1]

Instead of the aldehyde used in Example 1, 29.7 g (0.1 mol) of the aldehyde of formula (II-d) produced according to Example D) and 15.2 g (0.1 mol) of 4-chlorophenylacetonitrile were used.

Yield: 37.1 g (corresponds to 86% of theory), melting point in 93° C.

### Example 30

### Production of an Inventive Compound of Formula (I-30)

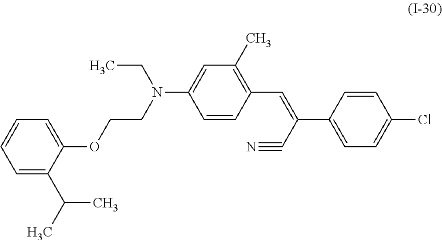 [SMILES: CCN(CCOc1ccccc1C(C)C)c1ccc(/C=C(\C#N)c2ccc(Cl)cc2)c(C)c1]

Instead of the aldehyde used in Example 1, 32.6 g (0.1 mol) of the aldehyde of formula (II-e) produced according to Example E) and 15.2 g (0.1 mol) of 4-chlorophenylacetonitrile were used.

Yield: 39.5 g (corresponds to 86% of theory), melting point in 107° C.

### Example 31

### Production of an Inventive Compound of Formula (1-31)

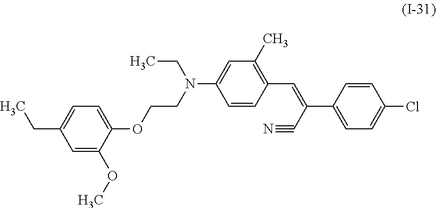 [SMILES: CCc1ccc(OCCN(CC)c2ccc(/C=C(\C#N)c3ccc(Cl)cc3)c(C)c2)c(OC)c1]

Instead of the aldehyde used in Example 1, 34.1 g (0.1 mol) of the aldehyde of formula (II-f) produced according to Example F) and 15.2 g (0.1 mol) of 4-chlorophenylacetonitrile were used.

Yield: 41.2 g (corresponds to 87% of theory), melting point in 85° C.

### Example 32

### Production of an Inventive Compound of Formula (I-32)

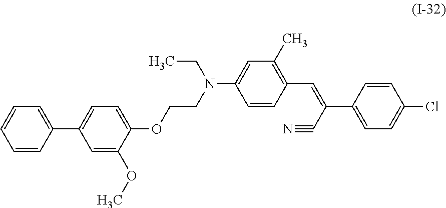 [SMILES: CCN(CCOc1ccc(-c2ccccc2)cc1OC)c1ccc(/C=C(\C#N)c2ccc(Cl)cc2)c(C)c1]

Instead of the aldehyde used in Example 1, 36.0 g (0.1 mol) of the aldehyde of formula (II-g) produced according to Example G) and 15.2 g (0.1 mol) of 4-chlorophenylacetonitrile were used.

Yield: 44.5 g (corresponds to 85% of theory), melting point in 88° C.

### Production of the Precursors

### Example A

### Production of an Aldehyde of Formula (II-a)

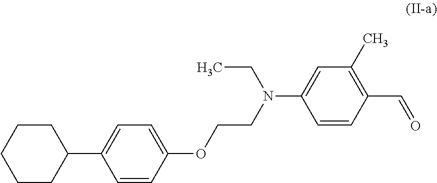 [SMILES: CCN(CCOc1ccc(C2CCCCC2)cc1)c1ccc(C=O)c(C)c1]

### a) Production of the Ether

176.3 g (1.0 mol) of 4-cyclohexylphenol and 197.7 g (1.0 mol) of N-(2-chloroethyl)-N-ethyl-3-methylaniline were metered into 500 ml of water. Subsequently, 84 g (1.05 mol) of a 50% aqueous sodium hydroxide solution was added. Heating to 95° C. was subsequently performed over the course of 180 minutes and the reaction mixture was then stirred for 12 hours. The reaction mixture was then left to stand for 4 hours until phase separation had occurred. The aqueous phase was subsequently separated off. Residual water was removed from the organic phase under reduced pressure at 80° C. and 2000 Pa.

### b) Production of the Aldehyde

Subsequently, 310 g (4.24 mol) of dimethylformamide was added dropwise to the organic phase from step a). 160 g (1.04 mol) of phosphorus oxychloride was then metered in over the course of 3 hours at a temperature of 60° C. The reaction mixture was then stirred for 5 hours. The mixture was subsequently cooled to 20° C. and admixed with 160 g of methanol and 400 g of water. The pH was adjusted to approx. 8 by addition of a 50% aqueous sodium hydroxide solution. The reaction mixture was left to stand for 4 hours until phase separation had occurred. The aqueous phase was then removed. Residual water was removed from the organic phase under reduced pressure at 80° C. and 2000 Pa.

Yield: 347.2 g (corresponds to 95% of theory).

### Example B

### Production of an Aldehyde of Formula (II-b)

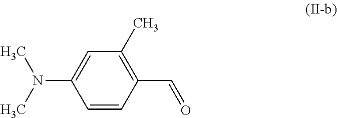

310 g (4.24 mol) of dimethylformamide was initially charged and 135.2 g (1.0 mol) of N,N-dimethyl-3-methylaniline was added dropwise thereto. Subsequently, 160 g (1.04 mol) of phosphorus oxychloride was metered in at 60° C. over the course of 3 hours. The reaction mixture was then stirred for 5 hours. The mixture was subsequently cooled to 20° C. and admixed with 160 g of methanol and 400 g of water. The pH was then adjusted to approx. 8 by addition of a 50% aqueous sodium hydroxide solution. The reaction mixture was left to stand for 4 hours until phase separation had occurred. The aqueous phase was then removed. Residual water was removed from the organic phase under reduced pressure at 80° C. and 2000 Pa.

Yield: 150.1 g (corresponds to 92% of theory).

### Example C

### Production of an Aldehyde of Formula (II-c)

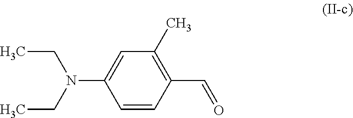

310 g (4.24 mol) of dimethylformamide was initially charged and 163.5 g (1.0 mol) of N,N-diethyl-3-methylaniline was added dropwise thereto. Subsequently, 160 g (1.04 mol) of phosphorus oxychloride was metered in at 60° C. over the course of 3 hours. The reaction mixture was stirred for 5 hours. The mixture was subsequently cooled to 20° C. and admixed with 160 g of methanol and 400 g of water. The pH was subsequently adjusted to approx. 8 with approx. 240 g of a 50% aqueous sodium hydroxide solution. The reaction mixture was left to stand for 4 hours until phase separation had occurred. The aqueous phase was then removed. Residual water was removed from the organic phase under reduced pressure at 80° C. and 2000 Pa.

Yield: 177.1 g (corresponds to 93% of theory).

### Example D

### Production of an Aldehyde of Formula (II-d)

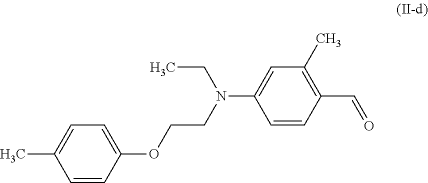 [SMILES: CCN(CCOc1ccc(C)cc1)c1ccc(C=O)c(C)c1]

### a) Production of the Ether

500 ml of water was initially charged and 108.1 g (1.0 mol) of p-phenylphenol and 197.7 g (1.0 mol) of N-(2-chloroethyl)-N-ethyl-3-methylaniline were added. Subsequently, 84 g (1.05 mol) of a 50% aqueous sodium hydroxide solution was added. Heating to 95° C. was subsequently performed over the course of 180 minutes and the reaction mixture was then stirred for 12 hours. The reaction mixture was then left to stand for 4 hours until phase separation had occurred. The aqueous phase was subsequently separated off. Residual water was removed from the organic phase under reduced pressure at 80° C. and 2000 Pa.

### b) Production of the Aldehyde

310 g (4.24 mol) of dimethylformamide was added dropwise to the organic phase from stage a). 160 g (1.04 mol) of phosphorus oxychloride was subsequently metered in over the course of 3 hours at a temperature of 60° C. The reaction mixture was then stirred for 5 hours. The mixture was subsequently cooled to 20° C. and admixed with 160 g of methanol and 400 g of water. The pH was subsequently adjusted to approx. 8 by addition of a 50% aqueous sodium hydroxide solution. The reaction mixture was left to stand for 4 hours until phase separation had occurred. The aqueous phase was then removed. Residual water was removed from the organic phase under reduced pressure at 80° C. and 2000 Pa.

Yield: 279.6 g (corresponds to 94% of theory)

### Example E

### Production of an Aldehyde of Formula (II-e)

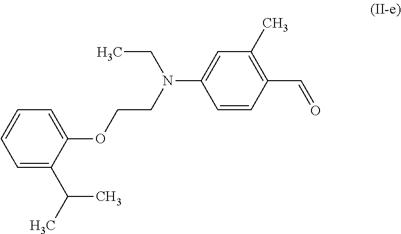 [SMILES: CCN(CCOc1ccccc1C(C)C)c1ccc(C=O)c(C)c1]

### a) Production of the Ether

500 ml of water was initially charged and 136.2 g (1.0 mol) of 2-isopropylphenol and 197.7 g (1.0 mol) of N-(2-chloroethyl)-N-ethyl-3-methylaniline were added. Subsequently, 84 g (1.05 mol) of a 50% aqueous sodium hydroxide solution was added. Heating to 95° C. was subsequently performed over the course of 180 minutes and the reaction mixture was then stirred for 12 hours. The reaction mixture was then left to stand for 4 hours until phase separation had occurred. The aqueous phase was subsequently separated off. Residual water was removed from the organic phase under reduced pressure at 80° C. and 2000 Pa.

### b) Production of the Aldehyde:

310 g (4.24 mol) of dimethylformamide was added dropwise to the organic phase from step a). 160 g (1.04 mol) of phosphorus oxychloride was subsequently metered in over the course of 3 hours at a temperature of 60° C. The reaction mixture was then stirred for 5 hours. The mixture was subsequently cooled to 20° C. and admixed with 160 g of methanol and 400 g of water. The pH was subsequently adjusted to approx. 8 by addition of a 50% aqueous sodium hydroxide solution. The reaction mixture was left to stand for 4 hours until phase separation had occurred. The aqueous phase was then removed. Residual water was removed from the organic phase under reduced pressure at 80° C. and 2000 Pa.

Yield: 309.2 g (corresponds to 95% of theory).

### Example F

### Production of an Aldehyde of Formula (II-f)

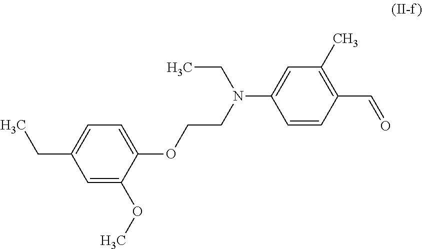 [SMILES: CCc1ccc(OCCN(CC)c2ccc(C=O)c(C)c2)c(OC)c1]

### a) Production of the Ether

500 ml of water was initially charged and 152.2 g (1.0 mol) of 2-methoxy-4-ethylphenol and 197.7 g (1.0 mol) of N-(2-chloroethyl)-N-ethyl-3-methylaniline were added. Subsequently, 84 g (1.05 mol) of a 50% aqueous sodium hydroxide solution was added. Heating to 95° C. was subsequently performed over the course of 180 minutes and the reaction mixture was then stirred for 12 hours. The reaction mixture was then left to stand for 4 hours until phase separation had occurred. The aqueous phase was subsequently separated off. Residual water was removed from the organic phase under reduced pressure at 80° C. and 2000 Pa.

### b) Production of the Aldehyde

310 g (4.24 mol) of dimethylformamide was added dropwise to the organic phase obtained in step a). 160 g (1.04 mol) of phosphorus oxychloride was subsequently metered in over the course of 3 hours at a temperature of 60° C. The reaction mixture was then stirred for 5 hours. The mixture was subsequently cooled to 20° C. and admixed with 160 g of methanol and 400 g of water. The pH was subsequently adjusted to approx. 8 by addition of a 50% aqueous sodium hydroxide solution. The reaction mixture was left to stand for 4 hours until phase separation had occurred. The aqueous phase was then removed. Residual water was removed from the organic phase under reduced pressure at 80° C. and 2000 Pa.

Yield: 324.3 g (corresponds to 95% of theory).

### Example G

### Production of an Aldehyde of Formula (II-g)

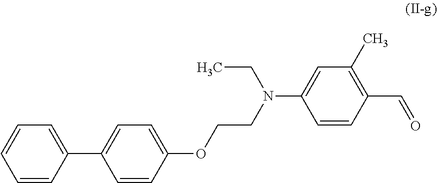 [SMILES: CCN(CCOc1ccc(-c2ccccc2)cc1)c1ccc(C=O)c(C)c1]

### a) Production of the Ether

500 ml of water was initially charged and 170.2 g (1.0 mol) of 4-phenylphenol and 197.7 g (1.0 mol) of N-(2-chloroethyl)-N-ethyl-3-methylaniline were added. Subsequently, 84 g (1.05 mol) of a 50% aqueous sodium hydroxide solution was added. Heating to 95° C. was subsequently performed over the course of 180 minutes and the reaction mixture was then stirred for 12 hours. The reaction mixture was then left to stand for 4 hours until phase separation had occurred. The aqueous phase was subsequently separated off. Residual water was removed from the organic phase under reduced pressure at 80° C. and 2000 Pa.

### b) Production of the Aldehyde

310 g (4.24 mol) of dimethylformamide was then added dropwise to the organic phase from step a). 160 g (1.04 mol) of phosphorus oxychloride was subsequently metered in over the course of 3 hours at a temperature of 60° C. The reaction mixture was then stirred for 5 hours. The mixture was subsequently cooled to 20° C. and admixed with 160 g of methanol and 400 g of water. The pH was subsequently adjusted to approx. 8 by addition of a 50% aqueous sodium hydroxide solution. The reaction mixture was stirred for 2 hours. The reaction product was then isolated at 20° C. on a suction filter. The filter cake was washed with approx. 300 ml of methanol and approx. 1000 ml of water at a temperature of 50° C. The washed product was dried in a vacuum drying cabinet at a temperature of 80° C. and a pressure of 20 000 Pa.

Yield: 341.5 g (corresponds to 95% of theory).

### List of Raw Materials Purchased:

| | Molecular | | | |
|---|---|---|---|---|
| Name: | weight | CAS No. | Content: | Manufacturer: |
| 4-Cyclohexylphenol | 176.3 | 1131-60-8 | 99 | Sigma-Aldrich |
| N-(2-Chloroethyl)-N-ethyl-3- | 197.7 | 22564-43-8 | 99 | Saltigo |
| methylaniline | | | | |
| N,N-Dimethyl-3-methylaniline | 135.2 | 121-72-2 | 97 | ABCR GmbH |
| N,N-Diethyl-3-methylaniline | 163.5 | 91-67-8 | 99 | ABCR GmbH |
| p-Cresol | 108.1 | 106-44-5 | 98 | Sigma-Aldrich |
| 2-Isopropylphenol | 136.2 | 88-69-7 | 98 | Sigma-Aldrich |
| 2-Methoxy-4-ethylphenol | 152.2 | 2785-89-9 | 98 | Sigma-Aldrich |
| 4-Phenylphenol | 170.2 | 92-69-3 | 97 | Sigma-Aldrich |
| 2-Fluorophenylacetonitrile | 135.1 | 459-23-3 | 98 | Alfa Aesar |
| 3-Fluorophenylacetonitrile | 135.1 | 501-00-8 | 98 | Alfa Aesar |
| 4-Fluorophenylacetonitrile | 135.1 | 459-22-3 | 98 | Alfa Aesar |
| 3,4-Dichlorophenylacetonitrile | 186.0 | 3218-49-3 | 98 | Alfa Aesar |
| 4-Chlorophenylacetonitrile | 151.6 | 140-53-4 | 98 | Alfa Aesar |
| 3-Chlorophenylacetonitrile | 151.6 | 1529-41-5 | 99 | Alfa Aesar |
| 2,6-Dichlorophenylacetonitrile | 186.0 | 3215-64-3 | 97 | Sigma-Aldrich |
| 2,4-Dichlorophenylacetonitrile | 186.0 | 6306-60-1 | 98 | Sigma-Aldrich |
| 4-Methoxyphenylacetonitrile | 147.2 | 104-47-2 | 97 | Sigma-Aldrich |
| 3-(Trifluoromethyl)phenylacetonitrile | 185.2 | 2338-76-3 | 97 | Sigma-Aldrich |

### Spectroscopic Measurements

The results of the UV/VIS measurements and absorbance values for the inventive compounds of Examples 1 to 32 are listed in Table 1.

TABLE 1

| | Absorption maximum | |
|---|---|---|
| Compound of | UV/VIS spectrum¹⁾ | E 1/1 value²⁾ |
| Example 1 | 399 nm | 520 |
| Example 2 | 384 nm | 506 |
| Example 3 | 384 nm | 280 |
| Example 4 | 385 nm | 392 |
| Example 5 | 404 nm | 491 |
| Example 6 | 384 nm | 519 |
| Example 7 | 408 nm | 620 |
| Example 8 | 395 nm | 515 |
| Example 9 | 404 nm | 572 |
| Example 10 | 394 nm | 568 |
| Example 11 | 405 nm | 744 |
| Example 12 | 386 nm | 809 |
| Example 13 | 382 nm | 803 |
| Example 14 | 399 nm | 630 |
| Example 15 | 380 nm | 815 |
| Example 16 | 392 nm | 708 |
| Example 17 | 389 nm | 743 |
| Example 18 | 390 nm | 713 |
| Example 19 | 382 nm | 747 |
| Example 20 | 417 nm | 902 |
| Example 21 | 388 nm | 790 |
| Example 22 | 389 nm | 852 |
| Example 23 | 410 nm | 692 |
| Example 24 | 389 nm | 930 |
| Example 25 | 401 nm | 749 |
| Example 26 | 399 nm | 790 |
| Example 27 | 399 nm | 690 |
| Example 28 | 390 nm | 794 |
| Example 29 | 403 nm | 638 |
| Example 30 | 394 nm | 523 |
| Example 31 | 395 nm | 498 |
| Example 32 | 395 nm | 350 |

¹⁾The UV/VIS absorption spectra of the inventive compounds were all measured in the solvent 1-methoxy-2-propyl acetate (CAS No. 108-65-6).
²⁾The E1/1 value specified is a hypothetical absorbance value which would be obtained if a 1 percent by weight solution of the respective compound (dissolved in 1-methoxy-2-propyl acetate) were to be measured in a cuvette with a path length of 1 cm.

### Performance Results

### Description of the “Thermal Stability” Test Method

In a tumble mixer, in each case 2 g of the dye to be tested was mixed with 1998 g of PA6 pellets of Durethan B30S type (commercial product from Lanxess Deutschland GmbH) with 1% TiO2 which had been dried at 80° C. for 4 hours. This mixture was extruded at a melt temperature of at most 240° C. in a single-screw extruder (Stork, 25 mm screw), cooled with water, pelletized using a Sheer pelletizer and dried at 80° C. for 8 hours. The heat stability of the resulting pelletized plastic was tested in accordance with DIN EN 12877-2 (“Determination of colour stability to heat during processing of colouring materials in plastics”) (Method A) on an injection moulding machine. As a standard, a sample was produced at 240° C. with a residence time in the screw of 2.5 minutes. The samples to be determined, which were produced with a residence time of 5 minutes and temperatures of 240-320° C., were colouristically evaluated against this standard sample. Samples with a total colour difference of dE≤3.0 were regarded as stable at the temperature employed.

The results of the determination of the thermal stability of the inventive compounds of Examples 1 to 32 and those of the non-inventive compounds of the prior art are listed in Table 2.

TABLE 2

| Example | Inventive | Heat-stable to (° C.) |
|---|---|---|
| 1 | Yes | 395 |
| 2 | Yes | 400 |
| 3 | Yes | 400 |
| 4 | Yes | 385 |
| 5 | Yes | 385 |
| 6 | Yes | 390 |
| 7 | Yes | 390 |
| 8 | Yes | 395 |
| 9 | Yes | 400 |
| 10 | Yes | 395 |
| 11 | Yes | 395 |
| 12 | Yes | 395 |
| 13 | Yes | 390 |
| 14 | Yes | 390 |
| 15 | Yes | 385 |
| 16 | Yes | 395 |
| 17 | Yes | 400 |
| 18 | Yes | 385 |
| 19 | Yes | 395 |
| 20 | Yes | 385 |
| 21 | Yes | 390 |
| 22 | Yes | 395 |
| 23 | Yes | 390 |
| 24 | Yes | 390 |
| 25 | Yes | 390 |
| 26 | Yes | 390 |
| 27 | Yes | 390 |
| 28 | Yes | 395 |
| 29 | Yes | 395 |
| 30 | Yes | 340 |
| 31 | Yes | 385 |
| 32 | Yes | 395 |
| EP-A 3470467, | No | 340° C. |
| Example 1 | | |
| EP-A 3470467, | No | 345° C. |
| Example 4 | | |
| EP-A 3470471, | No | 365° C. |
| Example 1 | | |
| EP-A 3470471, | No | 365° C. |
| Example 2 | | |
| EP-A 3 508 536, | No | 340° C. |
| Example 1 | | |
| EP-A 3 508 536, | No | 345° C. |
| Example 3 | | |
| EP-A 3247749, | No | 320° C. |
| Example 2 | | |
| EP-A 3247749, | No | 320° C. |
| Example 3 | | |
| D.Y. 201 (Macrolex ® | No | Decolourization |
| Yellow 6G) | | at 240° C. |
| S.Y. 93 (Macrolex ® | No | Decolourization |
| Yellow 3G) | | at 240° C. |
| S.Y. 114 (Macrolex ® | No | 240° C. |
| Yellow G) | | |
| S.Y. 160:1 (Macrolex ® | No | <240° C. |
| Fluorescent | | |
| Yellow 10GN) | | |

### CONCLUSION

As can be seen from Table 2, the dyes according to the invention have a significantly increased heat or thermal stability in comparison with the heat or thermal stabilities of the dyes of the prior art that are used for colouring plastics.

1. A substituted 4-amino-6-methylbenzaldehyde derivative of formula (I) 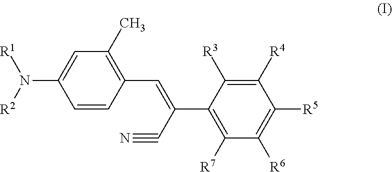
wherein
R¹ is methyl or ethyl,
R² is methyl or ethyl, or is methyl or ethyl which in each case is monosubstituted by a radical of formula 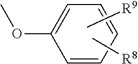
in which
R⁸ is methyl, ethyl, n-propyl, isopropyl, cyclohexyl or phenyl, and
R⁹ is hydrogen or methoxy,
R³ is hydrogen, fluorine or chlorine,
R⁴ is hydrogen, fluorine, chlorine or trifluoromethyl,
R⁵ is hydrogen, fluorine, chlorine or methoxy,
R⁶ is hydrogen, and
R⁷ is hydrogen or chlorine.

2. The substituted 4-amino-6-methylbenzaldehyde derivative according to claim 1, having any one of formulae (I-1) to (I-32)

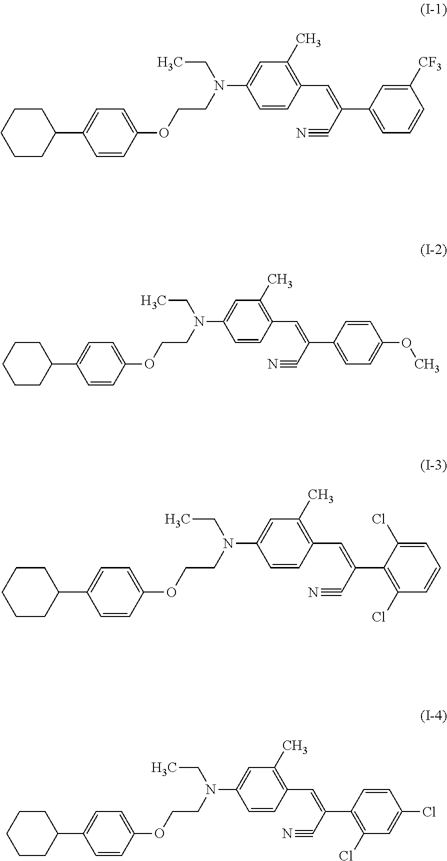 [SMILES: CCN(CCOc1ccc(C2CCCCC2)cc1)c1ccc(/C=C(\C#N)c2cccc(C(F)(F)F)c2)c(C)c1 ; CCN(CCOc1ccc(C2CCCCC2)cc1)c1ccc(/C=C(\C#N)c2ccc(OC)cc2)c(C)c1 ; CCN(CCOc1ccc(C2CCCCC2)cc1)c1ccc(/C=C(\C#N)c2c(Cl)cccc2Cl)c(C)c1 ; CCN(CCOc1ccc(C2CCCCC2)cc1)c1ccc(/C=C(\C#N)c2ccc(Cl)cc2Cl)c(C)c1]

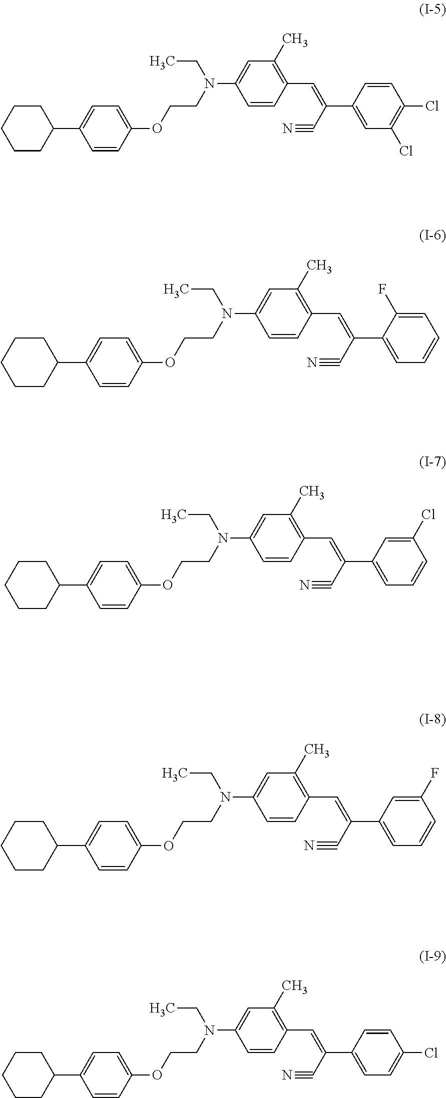 [SMILES: CCN(CCOc1ccc(C2CCCCC2)cc1)c1ccc(/C=C(\C#N)c2ccc(Cl)c(Cl)c2)c(C)c1 ; CCN(CCOc1ccc(C2CCCCC2)cc1)c1ccc(/C=C(\C#N)c2ccccc2F)c(C)c1 ; CCN(CCOc1ccc(C2CCCCC2)cc1)c1ccc(/C=C(\C#N)c2cccc(Cl)c2)c(C)c1 ; CCN(CCOc1ccc(C2CCCCC2)cc1)c1ccc(/C=C(\C#N)c2cccc(F)c2)c(C)c1 ; CCN(CCOc1ccc(C2CCCCC2)cc1)c1ccc(/C=C(\C#N)c2ccc(Cl)cc2)c(C)c1]

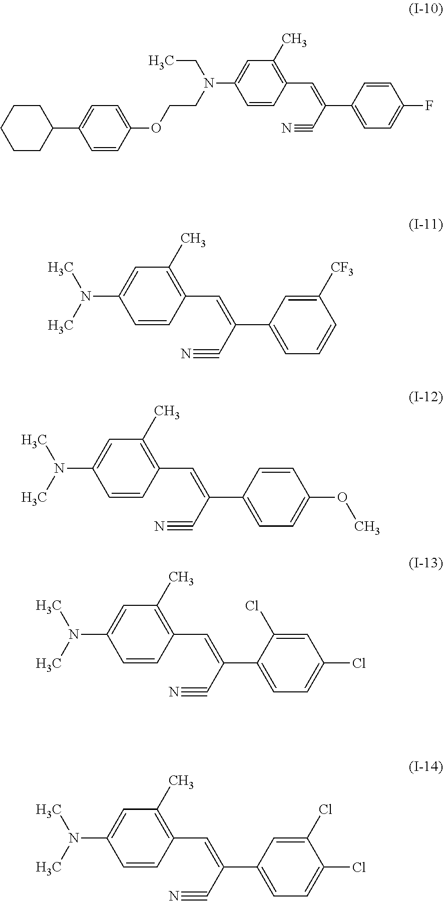

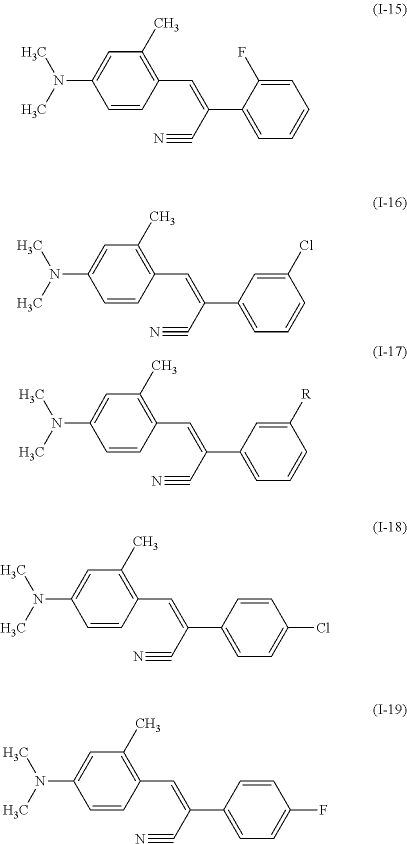

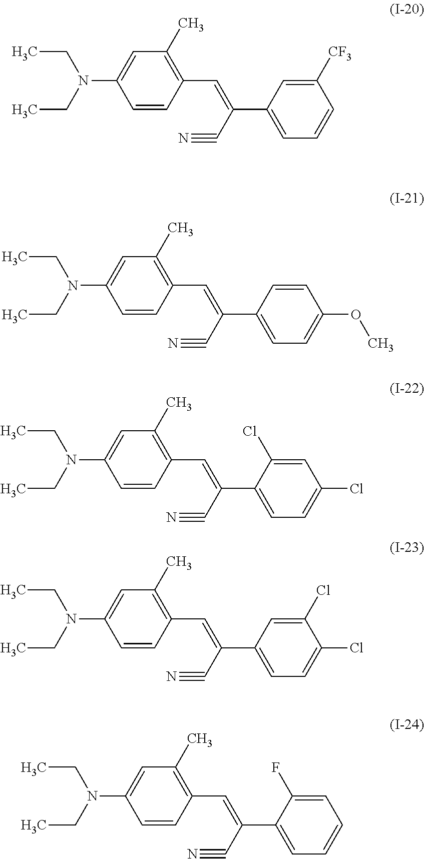

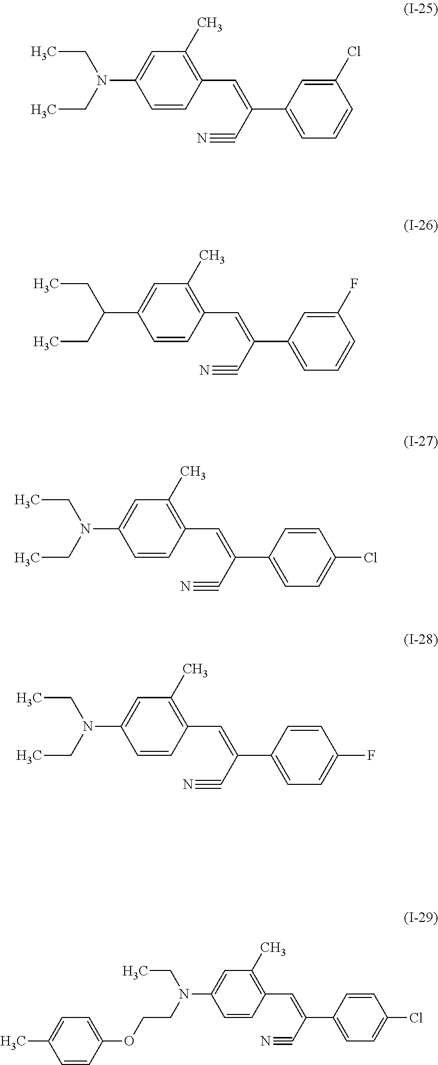 [SMILES: CCN(CC)c1ccc(/C=C(\C#N)c2cccc(Cl)c2)c(C)c1 ; CCC(CC)c1ccc(/C=C(\C#N)c2cccc(F)c2)c(C)c1 ; CCN(CC)c1ccc(/C=C(\C#N)c2ccc(Cl)cc2)c(C)c1 ; CCN(CC)c1ccc(/C=C(\C#N)c2ccc(F)cc2)c(C)c1 ; CCN(CCOc1ccc(C)cc1)c1ccc(/C=C(\C#N)c2ccc(Cl)cc2)c(C)c1]

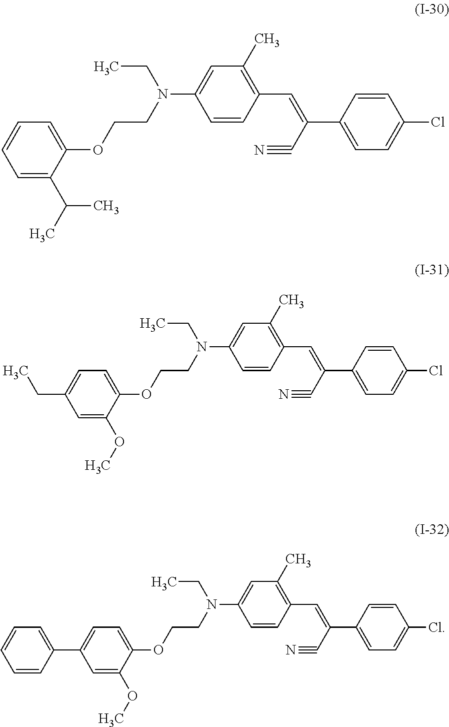 [SMILES: CCN(CCOc1ccccc1C(C)C)c1ccc(/C=C(\C#N)c2ccc(Cl)cc2)c(C)c1 ; CCc1ccc(OCCN(CC)c2ccc(/C=C(\C#N)c3ccc(Cl)cc3)c(C)c2)c(OC)c1 ; CCN(CCOc1ccc(-c2ccccc2)cc1OC)c1ccc(/C=C(\C#N)c2ccc(Cl)cc2)c(C)c1]

3. A thermally stable methine dye for plastics comprising at least one substituted 4-amino-6-methylbenzaldehyde derivative according to claim 1, wherein the thermally stable methine dye has a heat stability determined in accordance with DIN EN 12877-2 Method A on a respective pelletized plastic of ≥385° C.

4. The thermally stable methine dye according to claim 3, wherein the at least one substituted 4-amino-6-methylbenzaldehyde derivative is a compound of formulae (I-1) to (I-32)

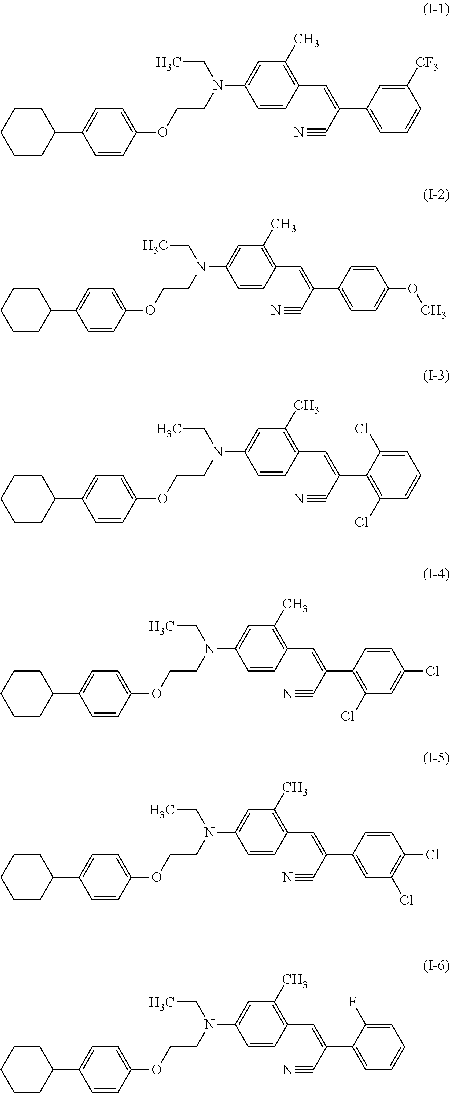 [SMILES: CCN(CCOc1ccc(C2CCCCC2)cc1)c1ccc(/C=C(\C#N)c2cccc(C(F)(F)F)c2)c(C)c1 ; CCN(CCOc1ccc(C2CCCCC2)cc1)c1ccc(/C=C(\C#N)c2ccc(OC)cc2)c(C)c1 ; CCN(CCOc1ccc(C2CCCCC2)cc1)c1ccc(/C=C(\C#N)c2c(Cl)cccc2Cl)c(C)c1 ; CCN(CCOc1ccc(C2CCCCC2)cc1)c1ccc(/C=C(\C#N)c2ccc(Cl)cc2Cl)c(C)c1 ; CCN(CCOc1ccc(C2CCCCC2)cc1)c1ccc(/C=C(\C#N)c2ccc(Cl)c(Cl)c2)c(C)c1 ; CCN(CCOc1ccc(C2CCCCC2)cc1)c1ccc(/C=C(\C#N)c2ccccc2F)c(C)c1]

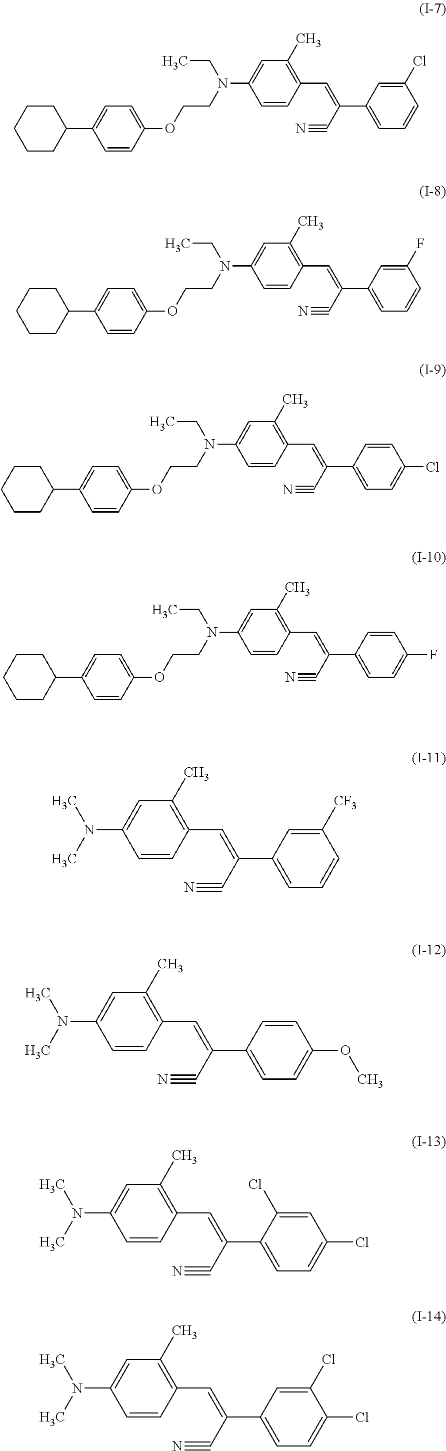

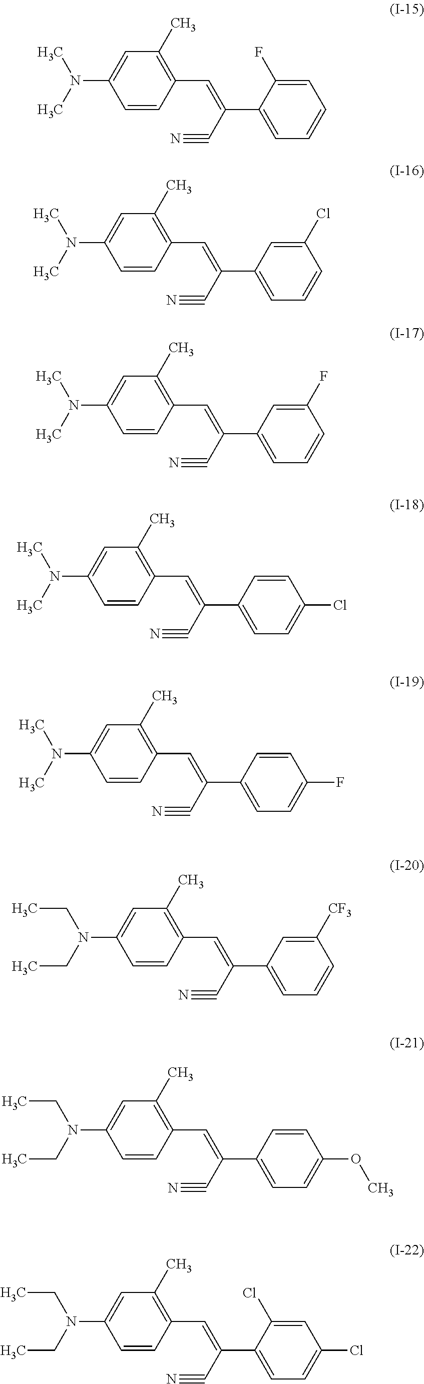

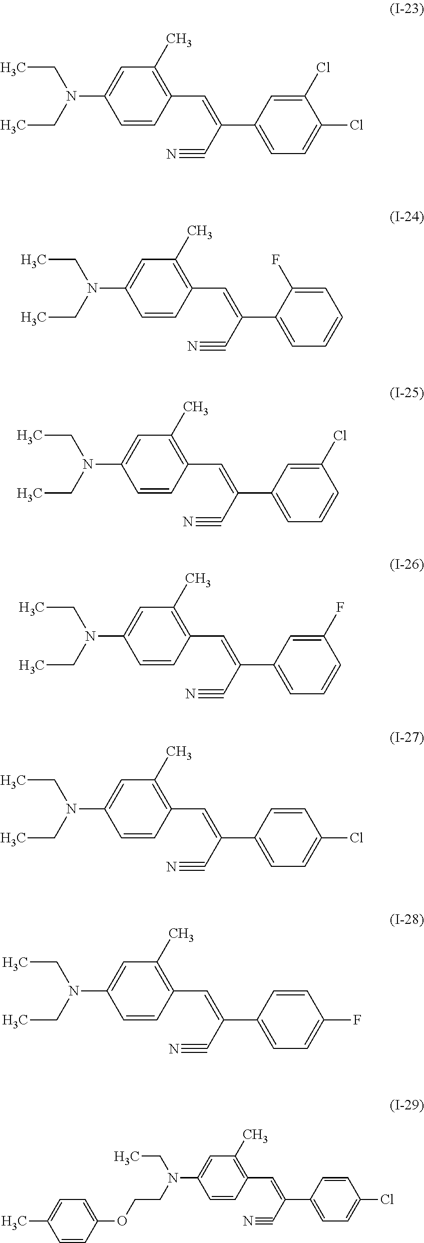

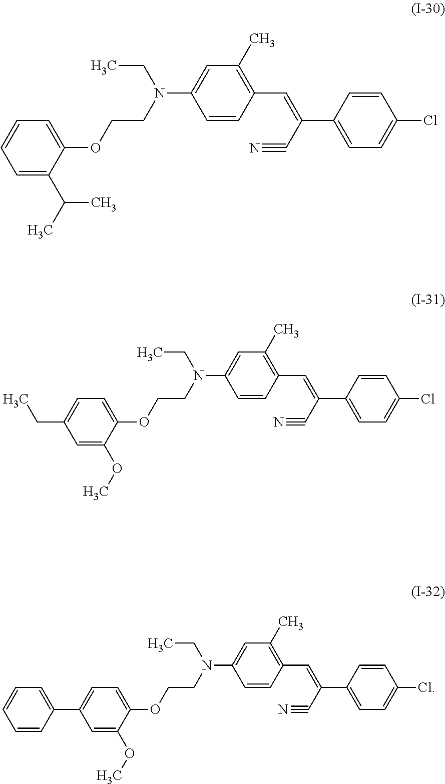 [SMILES: CCN(CCOc1ccccc1C(C)C)c1ccc(/C=C(\C#N)c2ccc(Cl)cc2)c(C)c1 ; CCc1ccc(OCCN(CC)c2ccc(/C=C(\C#N)c3ccc(Cl)cc3)c(C)c2)c(OC)c1 ; CCN(CCOc1ccc(-c2ccccc2)cc1OC)c1ccc(/C=C(\C#N)c2ccc(Cl)cc2)c(C)c1]

5.-10. (canceled)

11. A method for bulk colouring of plastics, comprising the steps of
grinding or mixing at least one substituted 4-amino-6-methylbenzaldehyde derivative of formula (I) 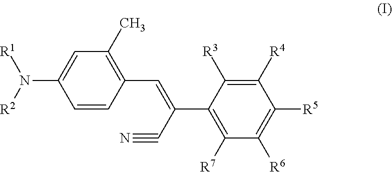
in dry form with at least one plastic, to form a plastic-colourant mixture,
wherein
R¹ is methyl or ethyl,
R² is methyl or ethyl, or is methyl or ethyl which is each case in monosubstituted by a radical of formula 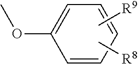
in which
R⁸ is methyl, ethyl, n-propyl, isopropyl, cyclohexyl or phenyl, and
R⁹ is hydrogen or methoxy,
R³ is hydrogen, fluorine or chlorine,
R⁴ is hydrogen, fluorine, chlorine, or trifluoromethyl,
R⁵ is hydrogen, fluorine, chlorine, or methoxy,
R⁶ is hydrogen, and
R⁷ is hydrogen or chlorine; and
melting and homogenizing the plastic-colourant mixture.

12. A method for bulk colouring of plastics, comprising the steps of
adding at least one substituted 4-amino-6-methylbenzaldehyde derivative of formula (I) 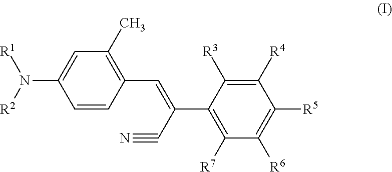
to a molten plastics compound comprising at least one plastic,
wherein
R¹ is methyl or ethyl,
R² is methyl or ethyl, or is methyl or ethyl which is each case in monosubstituted by a radical of formula 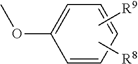
in which
R⁸ is methyl, ethyl, n-propyl, isopropyl, cyclohexyl or phenyl, and
R⁹ is hydrogen or methoxy,
R³ is hydrogen, fluorine or chlorine,
R⁴ is hydrogen, fluorine, chlorine, or trifluoromethyl,
R⁵ is hydrogen, fluorine, chlorine, or methoxy,
R⁶ is hydrogen, and
R⁷ is hydrogen or chlorine; and
subsequently homogenizing.

13. A method for bulk colouring of plastics, comprising the steps of
mixing at least one substituted 4-amino-6-methylbenzaldehyde derivative of formula (I) 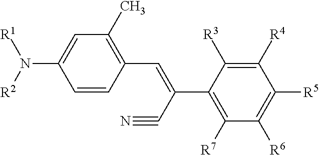
with monomeric reactants for producing at least one plastic,
wherein
R¹ is methyl or ethyl,
R² is methyl or ethyl, or is methyl or ethyl which is each case in monosubstituted by a radical of formula 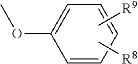
in which
R⁸ is methyl, ethyl, n-propyl, isopropyl, cyclohexyl or phenyl, and
R⁹ is hydrogen or methoxy,
R³ is hydrogen, fluorine or chlorine,
R⁴ is hydrogen, fluorine, chlorine, or trifluoromethyl,
R⁵ is hydrogen, fluorine, chlorine, or methoxy,
R⁶ is hydrogen, and
R⁷ is hydrogen or chlorine; and
polymerizing the mixture.

14.-15. (canceled)

16. The method according to claim 11, wherein the at least one substituted 4-amino-6-methylbenzaldehyde derivative is a compound of formulae (I-1) to (I-32)

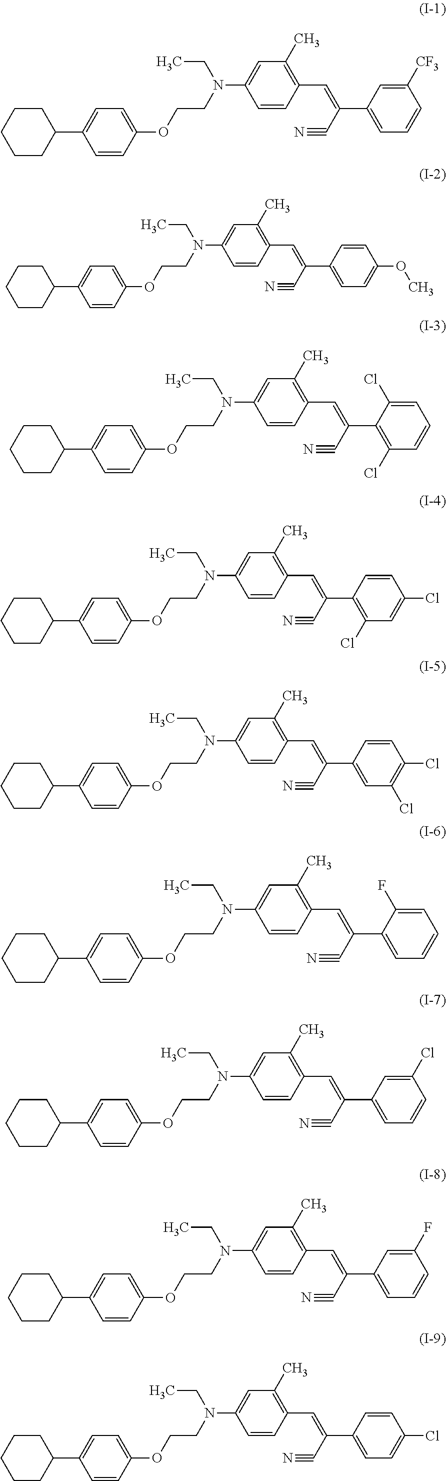

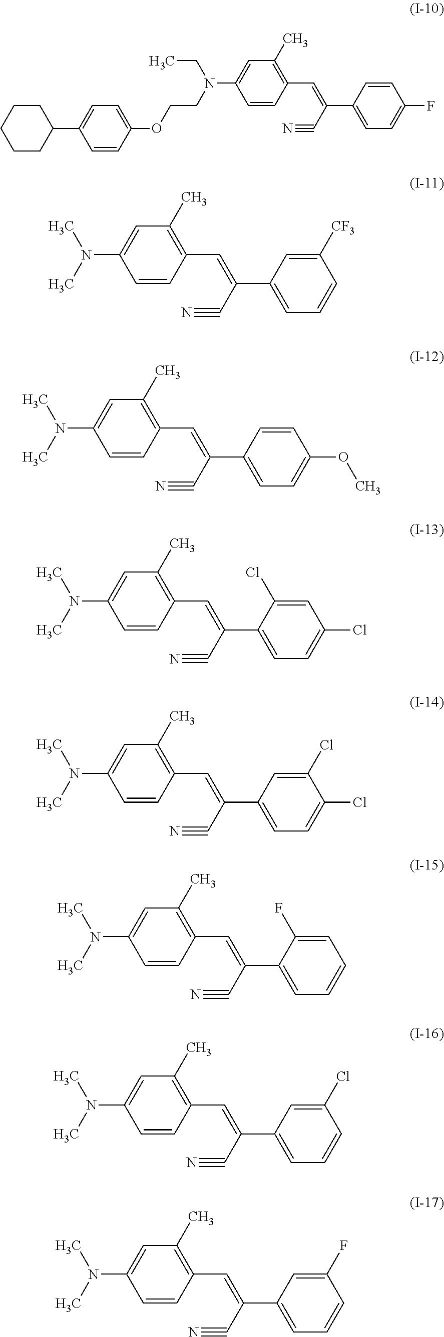

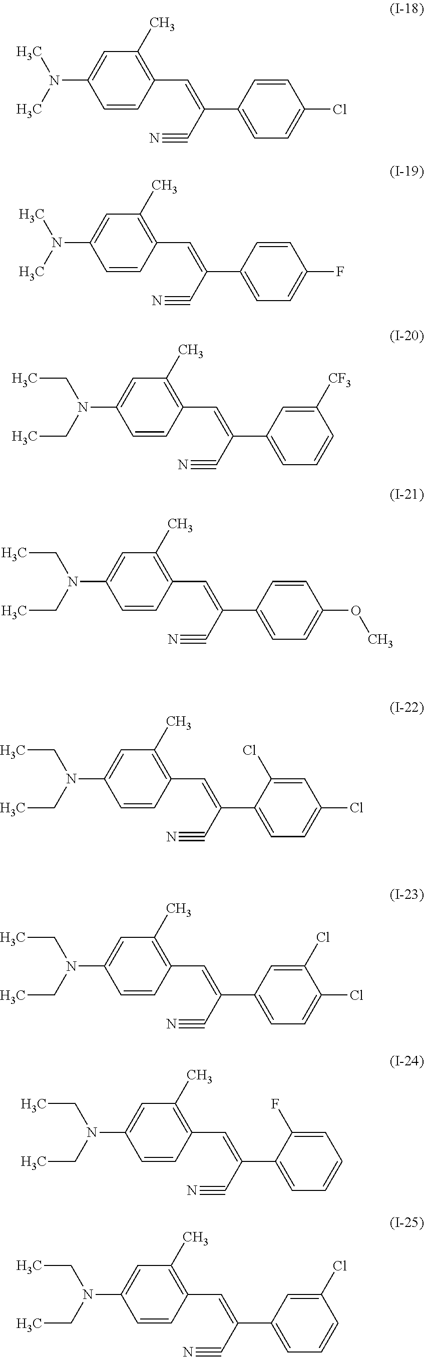

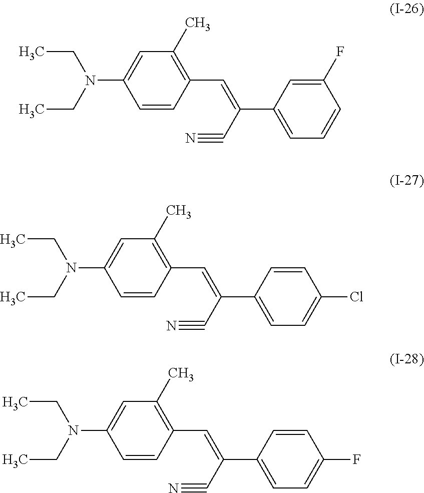 [SMILES: CCN(CC)c1ccc(/C=C(\C#N)c2cccc(F)c2)c(C)c1 ; CCN(CC)c1ccc(/C=C(\C#N)c2ccc(Cl)cc2)c(C)c1 ; CCN(CC)c1ccc(/C=C(\C#N)c2ccc(F)cc2)c(C)c1]

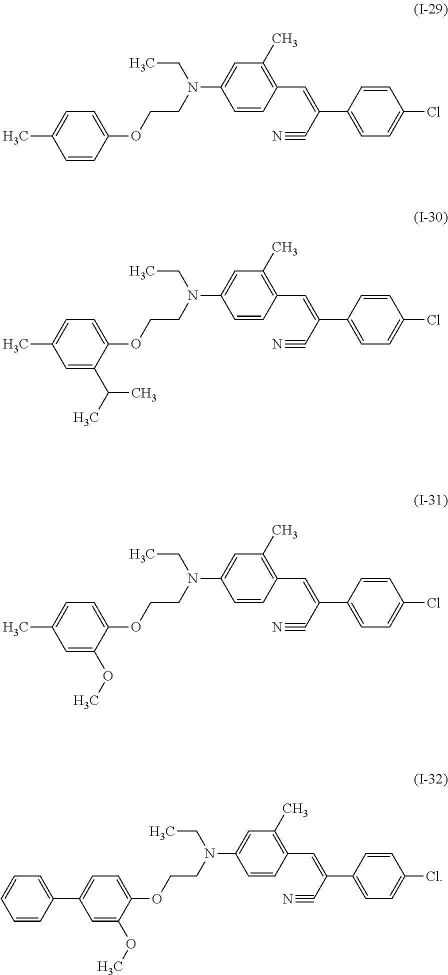 [SMILES: CCN(CCOc1ccc(C)cc1)c1ccc(/C=C(\C#N)c2ccc(Cl)cc2)c(C)c1 ; CCN(CCOc1ccc(C)cc1C(C)C)c1ccc(/C=C(\C#N)c2ccc(Cl)cc2)c(C)c1 ; CCN(CCOc1ccc(C)cc1OC)c1ccc(/C=C(\C#N)c2ccc(Cl)cc2)c(C)c1 ; CCN(CCOc1ccc(-c2ccccc2)cc1OC)c1ccc(/C=C(\C#N)c2ccc(Cl)cc2)c(C)c1]

17. The method according to claim 12, wherein the at least one substituted 4-amino-6-methylbenzaldehyde derivative is a compound of formulae (I-1) to (I-32)

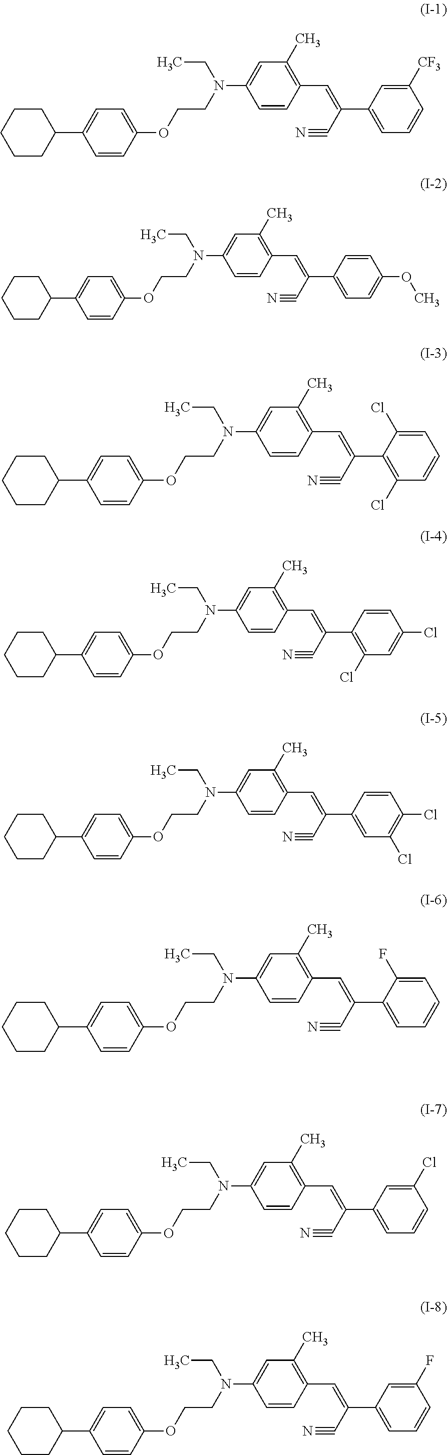

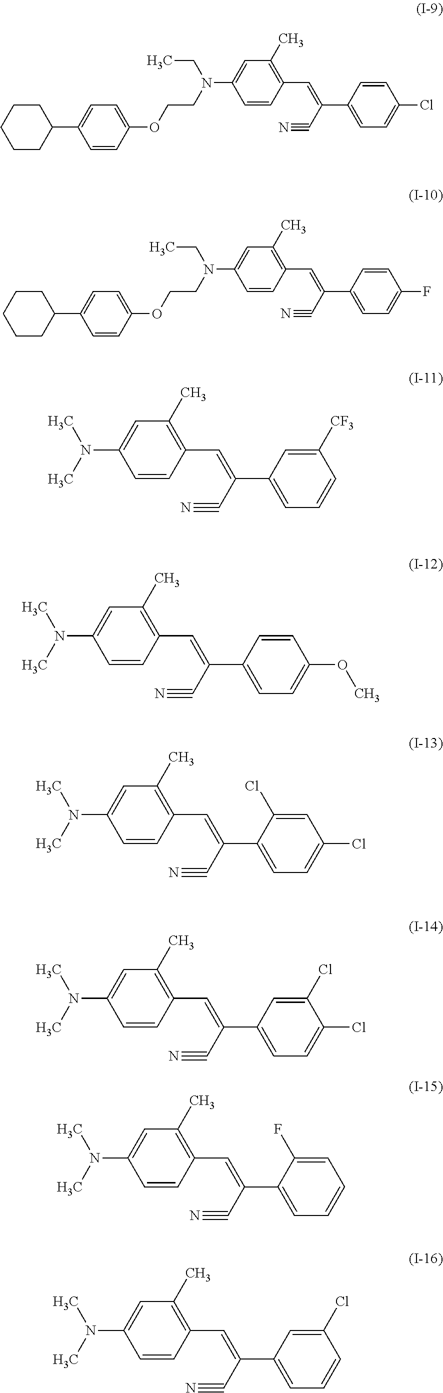

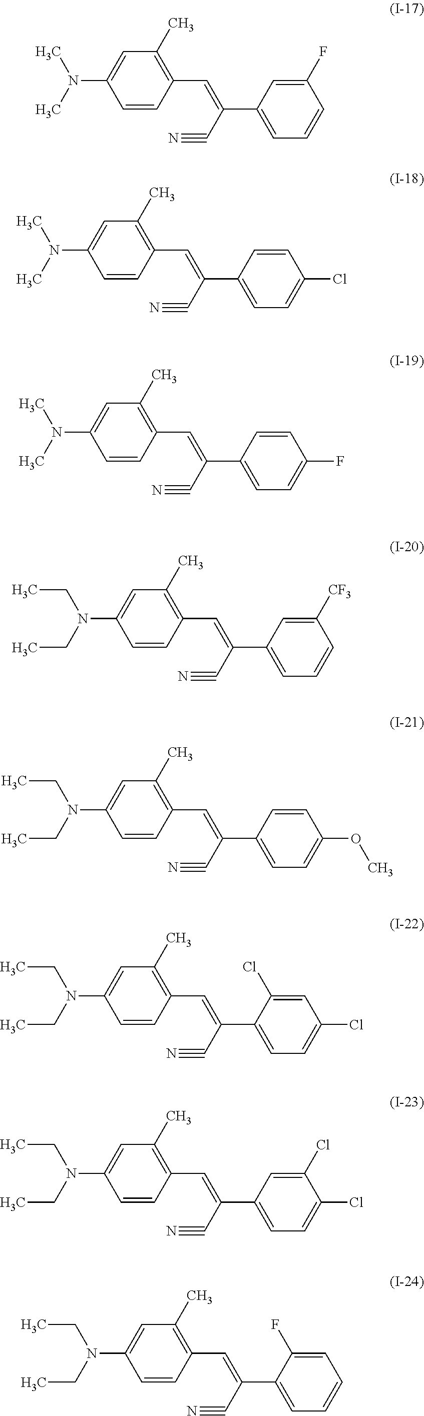

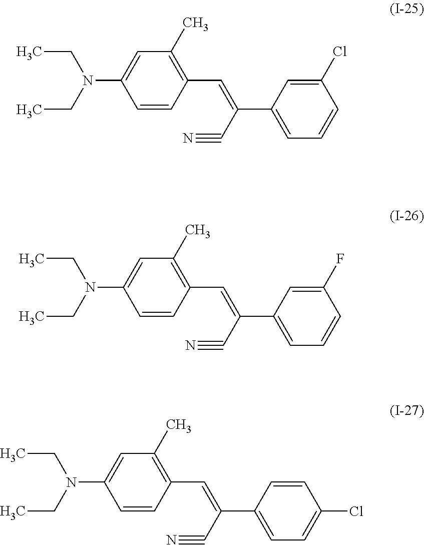 [SMILES: CCN(CC)c1ccc(/C=C(\C#N)c2cccc(Cl)c2)c(C)c1 ; CCN(CC)c1ccc(/C=C(\C#N)c2cccc(F)c2)c(C)c1 ; CCN(CC)c1ccc(/C=C(\C#N)c2ccc(Cl)cc2)c(C)c1]

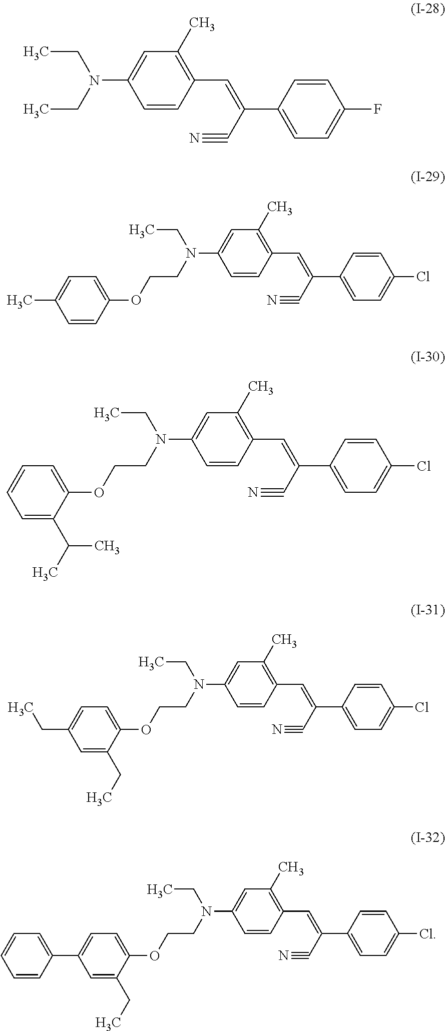 [SMILES: CCN(CC)c1ccc(/C=C(\C#N)c2ccc(F)cc2)c(C)c1 ; CCN(CCOc1ccc(C)cc1)c1ccc(/C=C(\C#N)c2ccc(Cl)cc2)c(C)c1 ; CCN(CCOc1ccccc1C(C)C)c1ccc(/C=C(\C#N)c2ccc(Cl)cc2)c(C)c1 ; CCc1ccc(OCCN(CC)c2ccc(/C=C(\C#N)c3ccc(Cl)cc3)c(C)c2)c(CC)c1 ; CCc1cc(-c2ccccc2)ccc1OCCN(CC)c1ccc(/C=C(\C#N)c2ccc(Cl)cc2)c(C)c1]

18. The method according to claim 13, wherein the at least one substituted 4-amino-6-methylbenzaldehyde derivative is a compound of formulae (I-1) to (I-32)

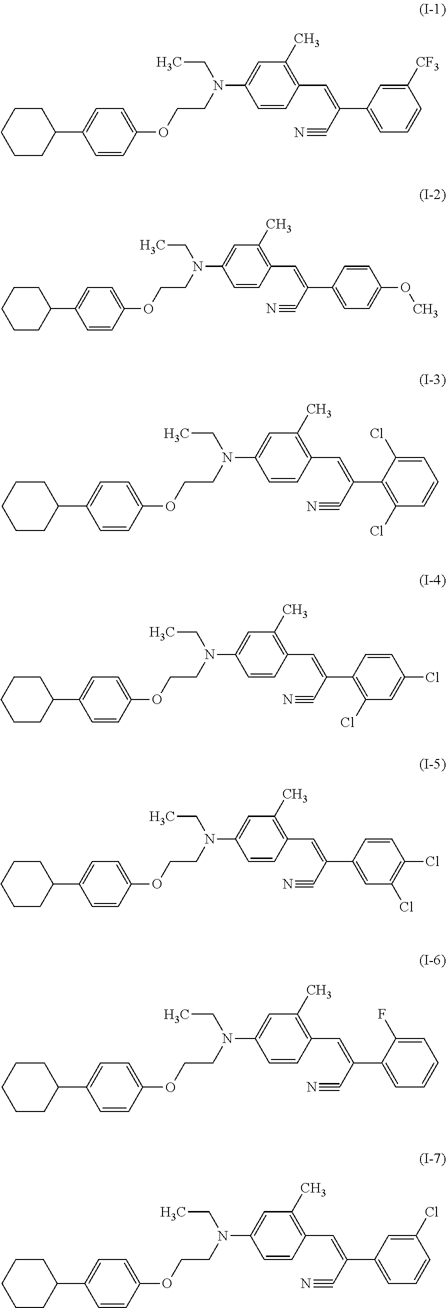

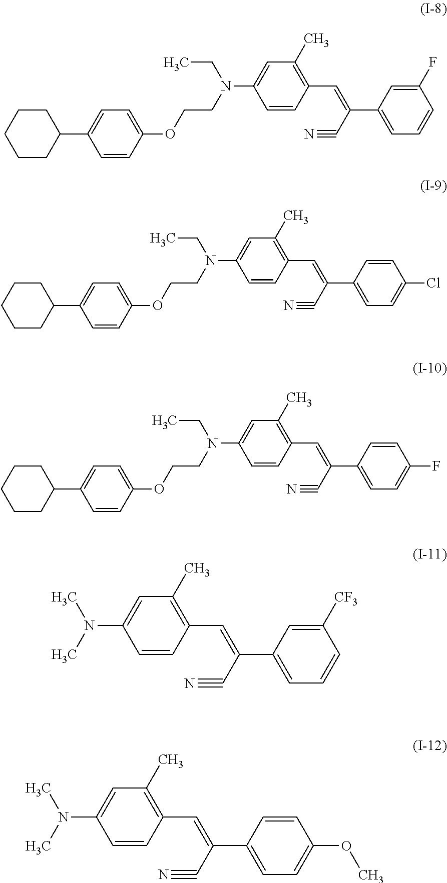

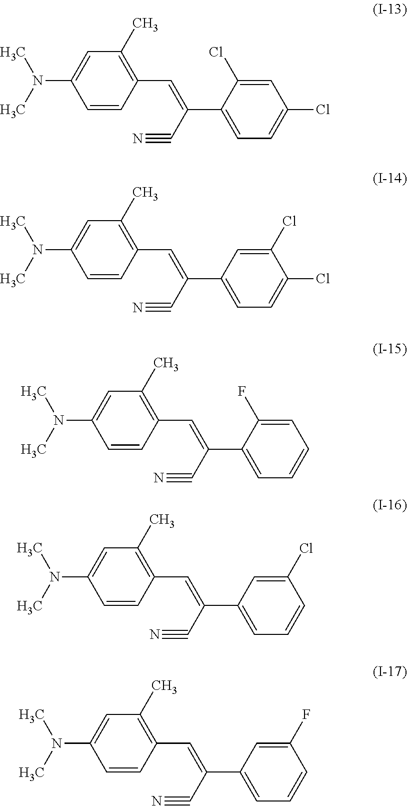

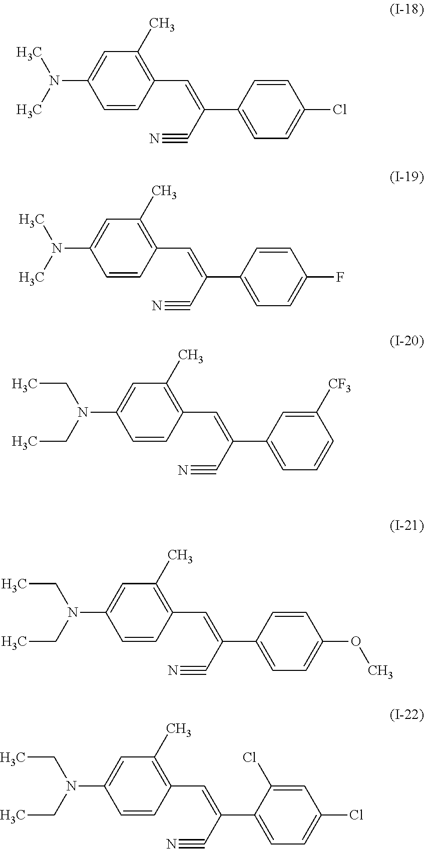

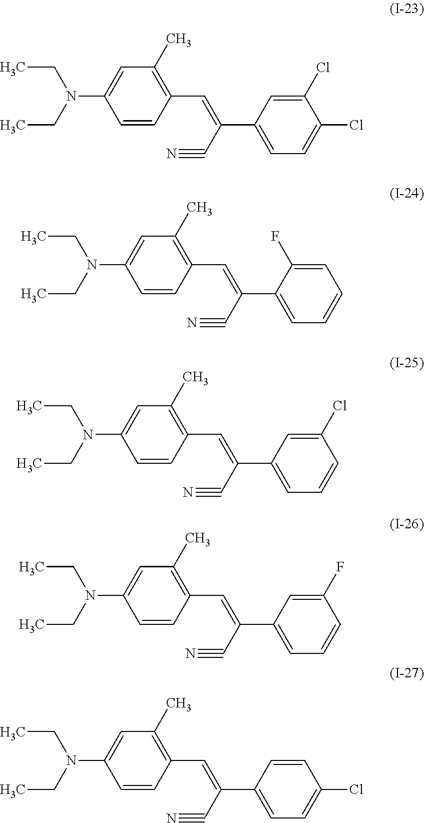

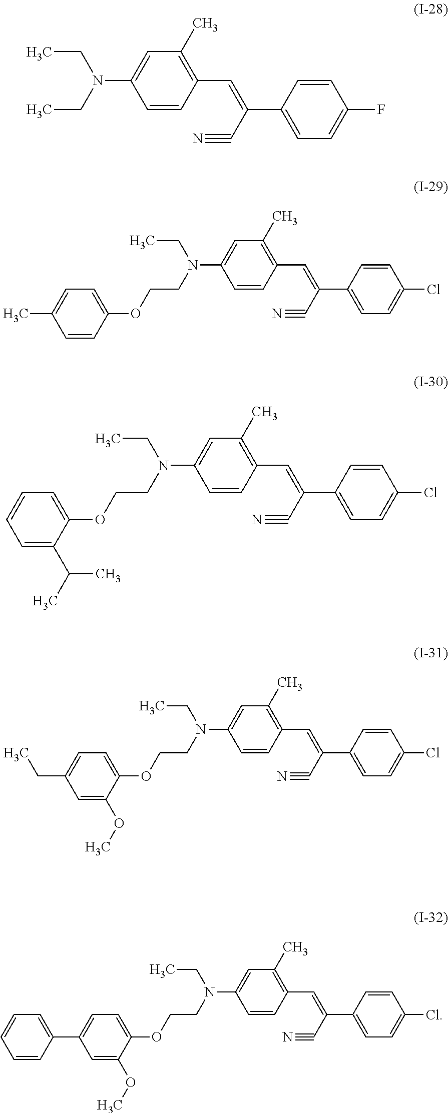 [SMILES: CCN(CC)c1ccc(/C=C(\C#N)c2ccc(F)cc2)c(C)c1 ; CCN(CCOc1ccc(C)cc1)c1ccc(/C=C(\C#N)c2ccc(Cl)cc2)c(C)c1 ; CCN(CCOc1ccccc1C(C)C)c1ccc(/C=C(\C#N)c2ccc(Cl)cc2)c(C)c1 ; CCc1ccc(OCCN(CC)c2ccc(/C=C(\C#N)c3ccc(Cl)cc3)c(C)c2)c(OC)c1 ; CCN(CCOc1ccc(-c2ccccc2)cc1OC)c1ccc(/C=C(\C#N)c2ccc(Cl)cc2)c(C)c1]

19. A plastic composition comprising at least one substituted 4-amino-6-methylbenzaldehyde derivative according to claim 1 and a plastic.

20. The plastic composition according to claim 19, wherein the at least one substituted 4-amino-6-methylbenzaldehyde derivative is a compound of formulae (I-1) to (I-32)

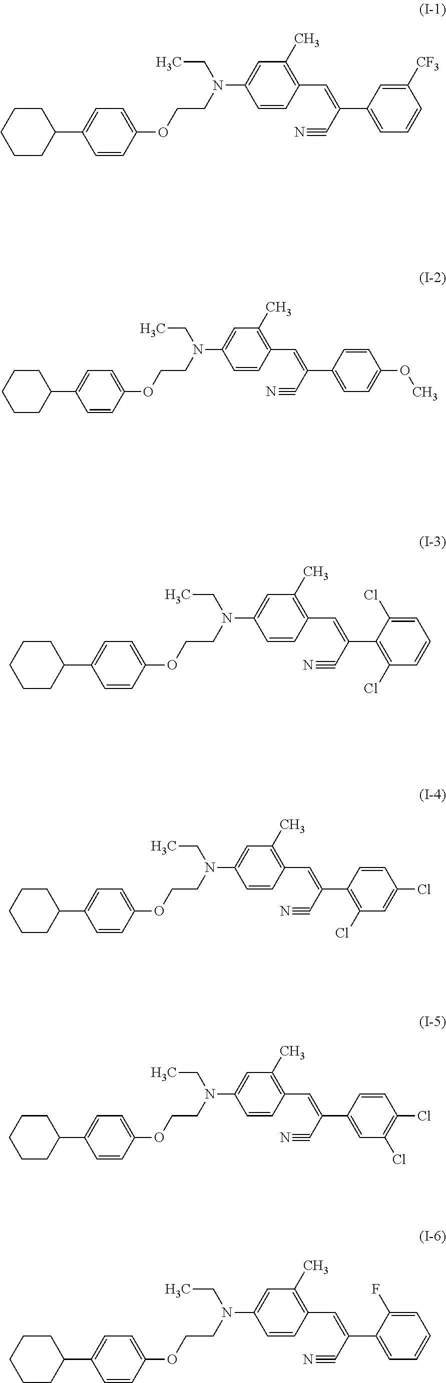 [SMILES: CCN(CCOc1ccc(C2CCCCC2)cc1)c1ccc(/C=C(\C#N)c2cccc(C(F)(F)F)c2)c(C)c1 ; CCN(CCOc1ccc(C2CCCCC2)cc1)c1ccc(/C=C(\C#N)c2ccc(OC)cc2)c(C)c1 ; CCN(CCOc1ccc(C2CCCCC2)cc1)c1ccc(/C=C(\C#N)c2c(Cl)cccc2Cl)c(C)c1 ; CCN(CCOc1ccc(C2CCCCC2)cc1)c1ccc(/C=C(\C#N)c2ccc(Cl)cc2Cl)c(C)c1 ; CCN(CCOc1ccc(C2CCCCC2)cc1)c1ccc(/C=C(\C#N)c2ccc(Cl)c(Cl)c2)c(C)c1 ; CCN(CCOc1ccc(C2CCCCC2)cc1)c1ccc(/C=C(\C#N)c2ccccc2F)c(C)c1]

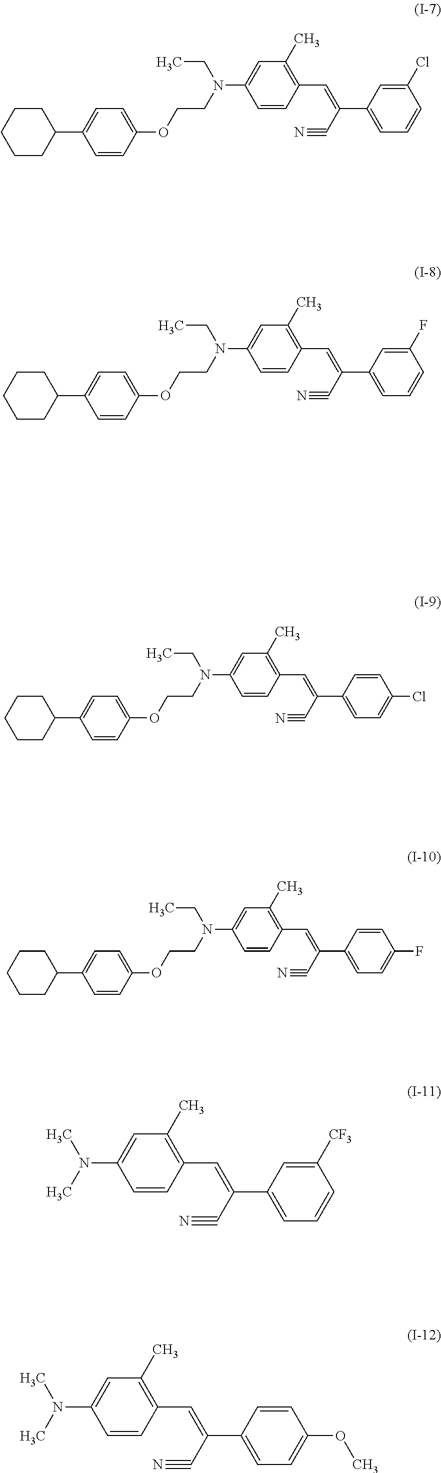

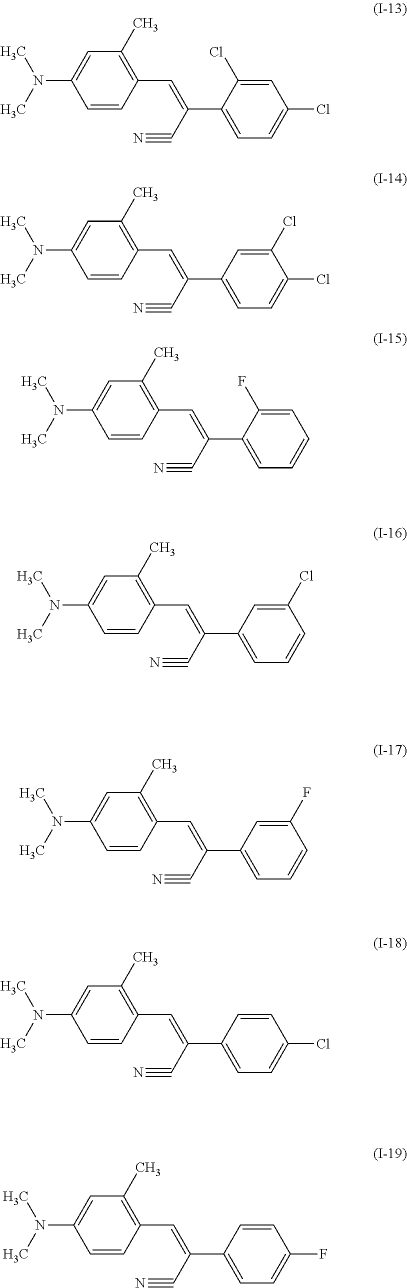

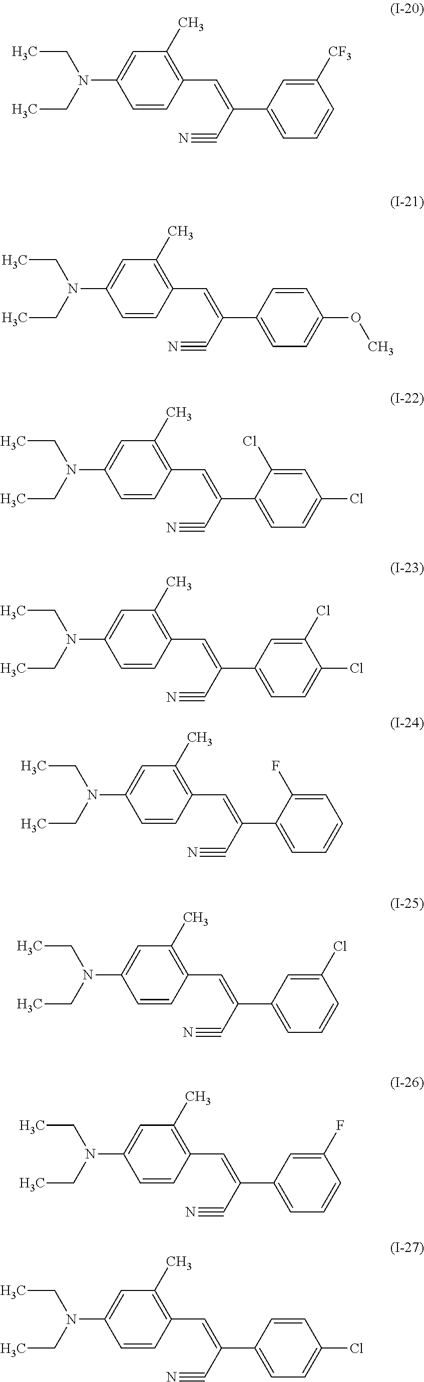

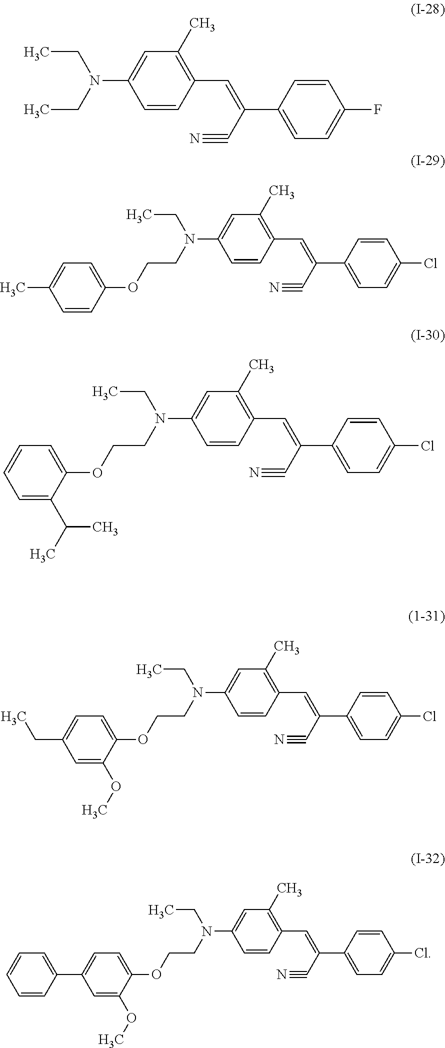 [SMILES: CCN(CC)c1ccc(/C=C(\C#N)c2ccc(F)cc2)c(C)c1 ; CCN(CCOc1ccc(C)cc1)c1ccc(/C=C(\C#N)c2ccc(Cl)cc2)c(C)c1 ; CCN(CCOc1ccccc1C(C)C)c1ccc(/C=C(\C#N)c2ccc(Cl)cc2)c(C)c1 ; CCc1ccc(OCCN(CC)c2ccc(/C=C(\C#N)c3ccc(Cl)cc3)c(C)c2)c(OC)c1 ; CCN(CCOc1ccc(-c2ccccc2)cc1OC)c1ccc(/C=C(\C#N)c2ccc(Cl)cc2)c(C)c1]

21. The plastic composition according to claim 19, wherein the plastic is a polyamide or a polymethylmethacrylate.

22. A molding comprising the plastic composition according to claim 19.
